(19) United States
(12) Patent Application Publication
(10) Pub. No.: US 2023/0125022 A1
(43) Pub. Date: Apr. 20, 2023

(54) PICKING SYSTEM AND METHOD

(71) Applicant: FANUC CORPORATION, Yamanashi (JP)

(72) Inventor: Weijia LI, Yamanashi (JP)

(73) Assignee: FANUC CORPORATION, Yamanashi (JP)

(21) Appl. No.: 17/905,403

(22) PCT Filed: Mar. 1, 2021
(86) PCT No.: PCT/JP2021/007734

§ 371 Date: Aug. 31, 2022

(30) Foreign Application Priority Data
Mar. 5, 2020 (JP) 2020-037638

(51) Int. Cl. B25J 9/16; B25J 9/02

(52) U.S. Cl. CPC B25J 9/163; B25J 9/023; B25J 9/1656; B25J 9/1697

(57) ABSTRACT

Provided is an picking system which can suitably extract a workpiece by machine learning. The picking system is provided with: a robot which has a hand; an acquisition unit which acquires a two-dimensional camera image of an area where a plurality of workpieces are present; a teaching unit which can display the two-dimensional camera image and teach an picking position of a target workpiece to be extracted by the hand from among the plurality of workpieces; a training unit which generates a trained model on the basis of the two-dimensional camera image and the taught picking position; an inference unit which infers the picking position of the target work on the basis of the trained model and the two-dimensional camera image; and a control unit which controls the robot to extract the target workpiece by means of the hand on the basis of the inferred picking position.

### TECHNICAL FIELD

The present invention relates to a picking system and a method.

### BACKGROUND ART

For example, there is used a workpiece picking system for picking a plurality of workpieces one by one from a container accommodating the workpieces using a robot. In the case where the plurality of workpieces are arranged to overlap with one another, a method is employed which causes the workpiece picking system to acquire, for example, a depth image (a two-dimensional image in which a distance to an object is expressed by gradation on a two-dimensional pixel-to-pixel basis) of the workpieces using a three-dimensional measurement device or the like, and to pick the workpieces using such a two-dimensional depth image. The work pieces are picked one by one preferentially from a workpiece which can be most easily picked, the workpiece being arranged on an upper position and having a large area of an exposure zone (hereinafter, referred to as a “high degree of exposure”), whereby a success rate of picking can be improved. To enable the workpiece picking system to automatically perform such a picking task, it is necessary to create a complex program for extracting characteristics such as vertices and planes of the workpiece by way of analysis of a depth image and estimating a position that facilitates picking of the workpiece from the extracted workpiece characteristics and to adjust vision parameters (image processing parameters).

In a conventional workpiece picking system, to make it possible to extract necessary characteristic values in the case where a shape of the workpiece is changed or in the case where a new workpiece is picked, it is necessary to newly create a program for estimating a position facilitating picking of the workpiece and newly adjust vision parameters. Since highly technical knowledge regarding vision is required to create such a program, a general user cannot easily create the program in a short period of time. There has been proposed a system in which a user teaches a position of a workpiece which is likely to be picked in a depth image of the workpiece, and a trained model for inferring a workpiece to be preferentially picked based on the depth image is generated by means of machine learning (supervised learning) based on the teaching data (for example, Patent Document 1).
Patent Document 1: Japanese Unexamined Patent Application, Publication No. 2019-58960

### DISCLOSURE OF THE INVENTION

### Problems to be Solved by the Invention

As described above, the system that performs the teaching in a depth image requires a relatively expensive three-dimensional measurement device. In the case of a glossy workpiece with strong specular reflection and a transparent or semitransparent workpiece through which light passes, an accurate distance cannot be measured, and therefore it is highly probable that only an incomplete depth image from which characteristics of the workpiece, such as a small groove, a step, a hole, a shallow recess, or a plane reflecting light, are omitted is obtained. With respect to such an incomplete depth image, a user performs erroneous teaching without being able to accurately recognize a correct shape, position and posture, and surrounding conditions of the workpiece, and therefore it is highly probable that the erroneous teaching data makes it impossible to appropriately generate a trained model for inferring a position of the workpiece to be picked.

In the case where a thin workpiece (e.g., a name card) is placed on a table, a container, a tray, or the like, a situation may be created in which a boundary line between the workpiece and a background environment disappears in the acquired depth image, thereby disabling a user from recognizing the presence or absence of the workpiece and the correct shape and size of the workpiece, and performing correct teaching. In the case where two workpieces of the same kind are arranged in full contact with each other (for example, two corrugated cardboards having the same size are arranged in the same orientation without leaving any gap there between), a boundary line between the workpieces in the adjacent area disappears in the acquired depth image, and the workpieces appear as one large-sized workpiece. With respect to such a depth image, the user performs erroneous teaching without being able to accurately recognize the presence or absence of the workpiece, the number of the workpieces, and the shape and size of the workpieces, and therefore it is highly probable that the erroneous teaching data makes it impossible to appropriately generate a trained model for inferring a position of the workpiece to be picked.

The depth image has limited information about surfaces of a workpiece which are only visible from a camera's perspective. When the depth image which cannot contain information about non-visible side surfaces of the workpiece is thus used, the user may perform erroneous teaching without knowing enough information, for example, characteristics of side surfaces of the workpiece, a positional relation with surrounding workpieces, and the like. For example, when the user teaches the system to grip and pick side surfaces of a workpiece without being able to recognize from the depth image, that a large and irregular recess is present on a side surface of the workpiece, a picking hand cannot stably grip the side surfaces of workpiece, and the picking operation results in failure. When the user teaches the system to suction and pick a workpiece from directly above without being able to recognize from the depth image, that an empty space is present directly underneath the workpiece, the workpiece escapes into the empty space directly underneath the workpiece upon receipt of a force applied in the downward direction in response to the picking operation of the hand, and the picking operation results in failure. Therefore, in the system that performs the teaching in the depth image, the user tends to perform erroneous teaching, and therefore the erroneous teaching data may make it impossible to appropriately generate a trained model for inferring a position of a workpiece to be picked.

It is desirable to provide a picking system and a method that can solve the above-described problem in that erroneous teaching and training are highly probably performed in the case of teaching and training using a depth image, and that make it possible to appropriately pick a workpiece by means of machine learning.

### Means for Solving the Problems

A picking system according to one aspect of the present disclosure includes a robot having a hand and capable of picking a workpiece using the hand, an acquisition unit configured to acquire a two-dimensional camera image of a zone containing a plurality of workpieces, a teaching unit configured to display the two-dimensional camera image and allow teaching a picking position of a target workpiece to be picked by the hand among the plurality of workpieces, a training unit configured to generate a trained model based on the two-dimensional camera image and the taught picking position, an inference unit configured to infer a picking position of the target workpiece based on the trained model and the two-dimensional camera image, and a control unit configured to control the robot to pick the target workpiece by the hand based on the inferred picking position.

A picking system according to another aspect of the present disclosure includes a robot having a hand and capable of picking a workpiece using the hand, an acquisition unit configured to acquire three-dimensional point cloud data of a zone containing a plurality of workpieces, a teaching unit configured to display the three-dimensional point cloud data in a 3D view, display the plurality of workpieces and a surrounding environment from a plurality of directions, and allow teaching a picking position of a target workpiece to be picked by the hand among the plurality of workpieces, a training unit configured to generate a trained model based on the three-dimensional point cloud data and the taught picking position, an inference unit configured to infer a picking position of the target workpiece based on the trained model and the three-dimensional point cloud data, and a control unit configured to control the robot to pick the target workpiece by the hand based on the inferred picking position.

A method according to still another aspect of the present disclosure is a method of picking a target workpiece from a zone containing a plurality of workpieces using a robot capable of picking a workpiece by a hand. The method includes: acquiring a two-dimensional camera image of the zone containing the plurality of workpieces; displaying the two-dimensional camera image and teaching a picking position of a target workpiece to be picked by the hand among the plurality of workpieces; generating a trained model based on the two-dimensional camera image and the taught picking position; inferring a picking position of the target workpiece based on the trained model and the two-dimensional camera image; and controlling the robot to pick the target workpiece by the hand based on the inferred picking position.

A method according to yet another aspect of the present disclosure is a method of picking a target workpiece from a zone containing a plurality of workpieces using a robot capable of picking a workpiece by a hand. The method includes: acquiring three-dimensional point cloud data of the zone containing the plurality of workpieces; displaying the three-dimensional point cloud data in a 3D view and displaying the plurality of workpieces and a surrounding environment from a plurality of directions, and teaching a picking position of a target workpiece to be picked by the hand among the plurality of workpieces; generating a trained model based on the three-dimensional point cloud data and the taught picking position; inferring a picking position of the target workpiece based on the trained model and the three-dimensional point cloud data; and controlling the robot to pick the target workpiece by the hand based on the inferred picking position.

### Effects of the Invention

The picking system according to the present disclosure can prevent erroneous teaching that is likely to be performed in the conventional teaching method using a depth image. Furthermore, a workpiece can be appropriately picked by way of machine learning based on the acquired correct teaching data.

### BRIEF DESCRIPTION OF THE DRAWINGS

FIG. 1 is a schematic diagram illustrating a configuration of a picking system according to a first embodiment of the present disclosure;

FIG. 2 is a block diagram illustrating a flow of information in the picking system of FIG. 1;

FIG. 3 is a block diagram illustrating a configuration of a teaching unit of the picking system of FIG. 1;

FIG. 4 is a diagram illustrating an example of a teaching screen on a two-dimensional camera image in the picking system of FIG. 1;

FIG. 5 is a diagram illustrating another example of a teaching screen on a two-dimensional camera image in the picking system of FIG. 1;

FIG. 6 is a diagram illustrating yet another example of a teaching screen on a two-dimensional camera image in the picking system of FIG. 1;

FIG. 7 is a block diagram illustrating a hierarchical structure of a convolutional neural network in the picking system of FIG. 1;

FIG. 8 is a diagram illustrating, as an example, inference of a picking position and setting of an order of priority for picking on a two-dimensional camera image in the picking system of FIG. 1;

FIG. 9 is a flowchart illustrating an example of a procedure of picking a workpiece in the picking system of FIG. 1;

FIG. 10 is a schematic diagram illustrating a configuration of a picking system according to a second embodiment of the present disclosure;

FIG. 11 is a diagram illustrating an example of a teaching screen on a 3D view of three-dimensional point cloud data in the picking system of FIG. 10;

FIG. 12 is a diagram illustrating an example of a teaching screen for an approach direction of a picking hand in the picking system of FIG. 10;

FIG. 13 is a schematic diagram illustrating a coulomb friction model; and

FIG. 14 is a schematic diagram for explaining evaluation of gripping stability in the coulomb friction model.

### PREFERRED MODE FOR CARRYING OUT THE INVENTION

There are two embodiments according to the present disclosure. Hereinafter, the two embodiments will be described.

### FIRST EMBODIMENT

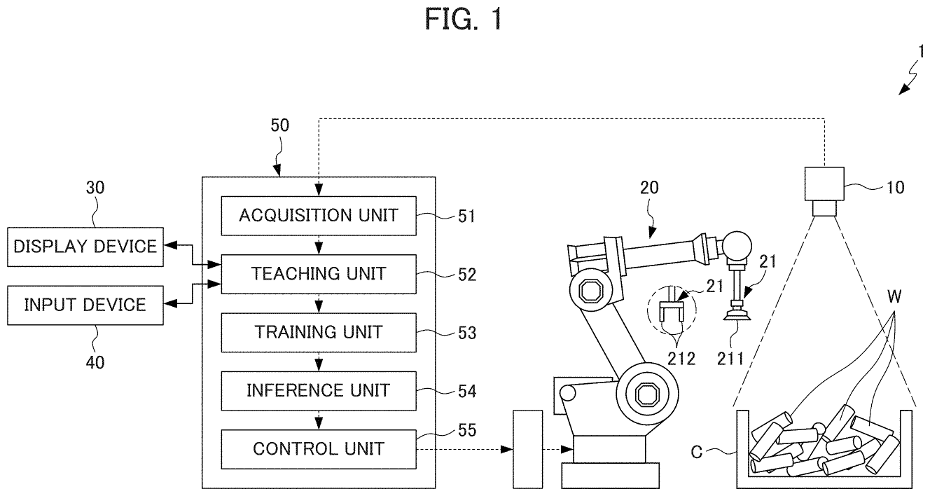

Hereinafter, an embodiment of a picking system according to the present disclosure will be described with reference to the drawings. FIG. 1 illustrates a configuration of a picking system 1 according to a first embodiment. The picking system 1 is a system for picking a plurality of workpieces W one by one from a zone (an inside of a container C) containing the workpieces W.

The picking system 1 includes an information acquisition device 10 configured to capture an image of the inside of the container C in which a plurality of workpieces W are accommodated to randomly overlap with one another, a robot 20 configured to pick a workpiece W from the container C, a display device 30 configured to display a two-dimensional image, an input device 40 that allows a user to perform an input operation, and a controller 50 configured to control the robot 20, the display device 30, and the input device 40.

The information acquisition device 10 may be configured as a camera for capturing a visible light image such as an RGB image and a grayscale image. Examples of such a camera configured to acquire an invisible light image include an infrared ray camera configured to acquire a heat image used for inspecting humans, animals, or the like, an ultraviolet ray camera configured to acquire an ultraviolet ray image used for inspecting flaws, spots, or the like on a surface of an object, an X ray camera configured to acquire an image used for diagnosing disease, and an ultrasonic camera configured to acquire an image used for exploring underwater. The information acquisition device 10 is disposed to capture an image of the entire inner space of the container C from above. In FIG. 1, the camera is fixed to the environment, but the present disclosure is not limited to the installation method, and a configuration may be adopted in which the camera is fixedly disposed to a hand tip of the robot 20 to capture an image of the inner space of the container C from different positions and angles while moving in response to movement of the robot. Alternatively, a configuration may be adopted in which the camera may be fixed to a hand tip of a robot different from the robot 20 that performs a picking operation and capture an image, and the robot 20 receives the acquired data and the processing result of the camera through communication with a controller of the different robot to perform the picking operation. The information acquisition device 10 may have a configuration for measuring a depth (a vertical distance from the information acquisition device 10 to an object) for each pixel of the captured two-dimensional image. Examples of the configuration for measuring such a depth include a laser scanner, a distance sensor such as an acoustic sensor, and a second camera or a camera moving mechanism constituting a stereo camera.

The robot 20 has, at its distal end, a picking hand 21 for holding a workpiece W. The robot 20 may be, but is not limited to, a vertical articulated type robot as illustrated in FIG. 1, and may be, for example, an orthogonal coordinate type robot, a scalar type robot, a parallel link type robot, or the like.

The picking hand 21 may have any configuration that can hold the workpieces W one by one. As an example, the picking hand 21 may have a suction pad 211 for suctioning a workpiece W, as illustrated in FIG. 1. In this way, the picking hand 21 may be a suction hand for suctioning a workpiece using air tightness, but may be an attraction hand with a strong attraction force which does not requires air tightness. The picking hand 21 may have a pair of gripping fingers 212 or three or more gripping fingers 212 for pinching and holding a workpiece W as an alternative enclosed by the two-dot chain line in FIG. 1, or may have a plurality of suction pads 211 (not illustrated). Alternatively, the picking hand 21 may have a magnetic hand (not illustrated) configured to hold a workpiece made of iron or the like with a magnetic force.

The display device 30 includes, for example, a liquid crystal display or an organic EL display that can display a two-dimensional image, and displays an image according to an instruction from the controller 50, which will be described later. The display device 30 may be integrated with the controller 50.

In addition to the two-dimensional image, a two-dimensional virtual hand P reflecting the two-dimensional shape and size of the picking hand 21 in a portion in contact with the workpiece may be drawn and displayed on the two-dimensional image by the display device 30. For example, a circle or ellipse reflecting the shape and size of a distal end of the suction pad, a rectangle reflecting the shape and size of a distal end of the magnetic hand, or the like is drawn on the two-dimensional image, so that a two-dimensional virtual hand P having the circular or elliptical shape or a two-dimensional virtual hand P having the rectangular shape can be always drawn and displayed instead of a normal arrow-shaped pointer pointed by a mouse. The two-dimensional virtual hand P having the circular or elliptical shape or the two-dimensional virtual hand P having the rectangular shape is moved on the two-dimensional image in response to a movement operation of the mouse, so as to overlap with a workpiece to be taught by the user on the two-dimensional image, and the user visually checks this state, which makes it possible to determine whether the virtual hand P interferes with surrounding workpieces of the workpiece and whether the virtual hand P significantly deviates from the center of the workpiece.

In the case where the number of positions where the picking hand 21 contacts a workpiece is two or more, in addition to the display of the two-dimensional image, a two-dimensional virtual hand P reflecting the orientation (two-dimensional posture) and the center position of the picking hand 21 in portions contacting the workpiece is drawn and displayed on the two-dimensional image by the display device 30. For example, with respect to a hand having two suction pads, a straight line connecting two centers of circles or ellipses representing the respective suction pads is drawn and displayed, and a dot is drawn and displayed at a middle point of the straight line, or with respect to the gripping hand having two gripping fingers, a straight line connecting two centers of rectangles representing the respective gripping fingers is drawn and displayed, and a dot is drawn and displayed at a middle point of the straight line. In the case where a target workpiece to be picked is not a spherical workpiece with no orientation around 360□, for example, in the case where an elongated rotary workpiece with an orientation is to be picked, the user can teach a picking center position by placing the dot representing the picking center position of the hand in the proximity of the center of gravity of the workpiece, and teach a posture of the two-dimensional visual hand P by aligning the above-described straight line representing a longitudinal direction of the hand with an axial direction which is a longitudinal direction of the rotary axis. This enables the hand to hold the workpiece in a well-balanced state without significantly deviating from the center of gravity of the workpiece, and enables two suction pads or gripping fingers to hold the workpiece stably by contacting the workpiece at two points and to stably pick a workpiece like an elongated rotary shaft with an orientation.

In the case where the number of positions where the picking hand 21 contacts a workpiece is two or more, in addition to the display of the two-dimensional image, a two-dimensional virtual hand P reflecting the interval of the picking hand 21 between portions contacting the workpiece is drawn and displayed on the two-dimensional image by the display device 30. For example, with respect to a hand having two suction pads, a straight line representing a distance between two centers of the circles or ellipses representing the respective suction pads is drawn and displayed, a value of the distance between the centers is numerically displayed, and a dot is drawn at a middle point of the straight line so as to be displayed as a picking center position of the hand. Similarly, with respect to a gripping hand having two gripping fingers, a straight line representing a distance between two centers of the rectangles representing the respective gripping fingers is drawn and displayed, a value of the distance between the centers is numerically displayed, and a dot is drawn at a middle point of the straight line so as to be displayed as a picking center position of the hand. Such a virtual hand P overlaps with a target workpiece on the two-dimensional image, which enables the user to reduce a distance between the centers of the suction pads or the gripping fingers so that the suction pads or the gripping fingers do not interfere with surrounding workpieces of the target workpiece, and to teach the interval of the hand. The user visually checks the distance between the centers which is numerically displayed, which makes it possible to determine whether the value exceeds a motion range of the hand and is substantially infeasible. From an alarm message displayed on a pop up screen when the value exceeds the motion range, the user reduces the distance between the centers, which makes it possible to teach the interval of the hand which is substantially feasible.

In addition to the display of the two-dimensional image, a two-dimensional virtual hand P reflecting the two-dimensional shape and size of the picking hand 21 in a portion contacting the workpiece, and a combination of the orientation (two-dimensional posture) and the interval of the hand may be drawn and displayed on the two-dimensional image by the display unit 30.

In addition to the two-dimensional image, a simple mark such as a small dot, a circle, or a triangle may be drawn at a teaching position on the two-dimensional image that has been taught by the user by way of a teaching unit 52, which will be described later, and displayed on the two-dimensional image by the display device 30. From the simple mark, the user can know a position on the two-dimensional image that has been taught and a position on the two-dimensional image that has not been taught, and whether the total number of teaching positions is too small. Furthermore, the user can check whether the position that has already been taught really deviates from the center of the workpiece and whether an unintended position has been erroneously taught (for example, the mouse is erroneously clicked twice at the proximal position). Furthermore, in the case where the teaching positions are of different types, i.e., in the case where a plurality of kinds of workpieces coexist, for example, the teaching may be performed such that different marks are drawn and displayed on teaching positions on the different workpieces, a dot is drawn on a teaching position on a columnar workpiece, and a triangle is drawn on a teaching position on a cubic workpiece, thereby making the teaching positions distinguishable from each other.

By the display device 30, a two-dimensional virtual hand P may be displayed on the two-dimensional image, and a value of the depth of the pixel on the two-dimensional image may be numerically displayed, the pixel being pointed by the two-dimensional virtual hand P. The two-dimensional virtual hand P may be displayed on the two-dimensional image, and may be displayed while changing the size of the two-dimensional virtual hand P according to the depth information for each pixel on the two-dimensional image. Alternatively, both may be displayed. Even among the same workpieces, there is a phenomenon in which as the depth from the image capturing position of the camera to a workpiece is increased, the workpiece shown in the image appears smaller. At this time, the two-dimensional virtual hand P is reduced in size according to the depth information and is displayed so that the size ratio between each workpiece and the two-dimensional virtual hand P shown in the image coincides with the actual dimensional ratio between each workpiece and the picking hand 21 in the real world, which enables the user to accurately grasp the situation of the real world and correctly perform teaching.

The input device 40 may be, for example, a unit such as a mouse, a keyboard, or a touch panel to which the user can input the information. For example, the user can enlarge or reduce the displayed two-dimensional image with finger operations (for example, like pinch-in and pinch-out operations such as the finger operations on a smartphone) on the touch pad by turning a mouse wheel or pressing a key on the keyboard to check the shape (for example, the presence or absence of a step, a groove, a hole, or a recess, or the like) of the detailed portion of the workpiece and the surrounding situation (for example, a position of a boundary line with the adjacent workpiece) of the workpiece, and then perform teaching. The user moves the displayed two-dimensional image with the finger operations (for example, like finger operations on the smartphone) on the touch pad by moving the mouse while clicking on a right button of the mouse or by pressing a key (e.g., a direction key) on the keyboard to check a zone to be focused on by the user. The user clicks on a left button of the mouse, a key on the keyboard, the touch pad, or the like, to teach a position to be taught by the user.

The input device 40 may be a unit such as a microphone, whereby the user inputs a voice command, and the controller 50 receives the voice command and performs voice recognition to automatically perform the teaching according to the contents of the voice command. For example, when receiving a voice command “a center of a white plane” from the user, the controller 50 recognizes three keywords such as “white,” “plane,” and “center,” and estimates characteristics of “white” and “plane” by image processing, and performs automatically the teaching of a “center” position of the estimated “white plane” as a teaching position.

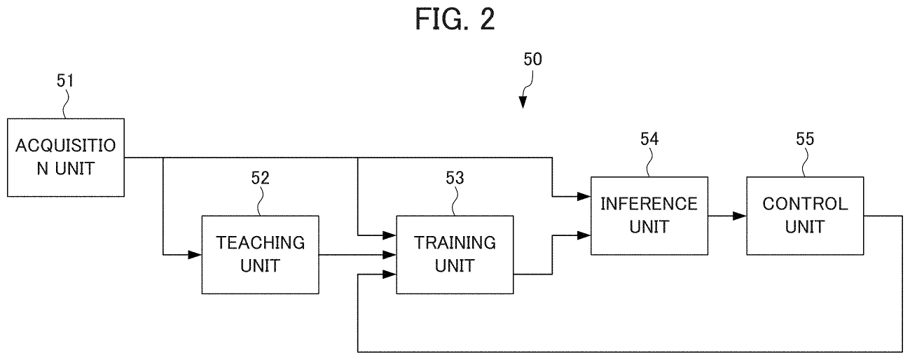

Alternatively, the input device 40 may be a unit such as a touch panel integrated with the display device 30. In addition, the input device 40 may be integrated with the controller 50. In this case, the user performs the teaching using the touch panel or the keyboard of a teach pendant of the controller 50. FIG. 2 illustrates a flow of information among constituent elements of the controller 50.

The controller 50 can cause one or a plurality of computer devices to execute an appropriate program, the computer device including a CPU, a memory, a communication interface, and the like. The controller 50 includes an acquisition unit 51, a teaching unit 52, a training unit 53, an inference unit 54, and a control unit 55. These constituent elements are distinguished functionally, and may not necessarily being distinguished clearly in a physical structure and a program structure.

The acquisition unit 51 acquires two-and-a-half dimensional image data (data including a two-dimensional camera image and depth information for each pixel of the two-dimensional camera image) of a zone containing a plurality of workpieces W. The acquisition unit 51 may receive, from the information acquisition device 10, the two-and-a-half dimensional image data including the two-dimensional camera image and the depth information, or may receive, from the information acquisition device 10 having no function of measuring depth information, only two-dimensional camera image data and estimate the depth for each pixel by analyzing the two-dimensional camera image data to generate the two-and-a-half dimensional image data. The two-and-a-half dimensional image data may be described as the image data as follows.

A method of estimating the depth from the two-dimensional camera image data acquired from one camera not having a function of measuring the depth information includes a method of using that the farther the object is from the information acquisition device 10, the smaller the size of the object shown in the two-dimensional camera image is. Specifically, without changing the arrangement of the workpieces in the container C, the acquisition unit 51 can calculate the depth (the distance from the camera) of the pixel in which a workpiece W is present based on the data acquired by capturing a plurality of images of the same arrangement state in the same container C from different distances (of which distance information is known) and based on the size of the workpiece W or the characteristic portion of the workpiece W on the two-dimensional camera image newly captured. Alternatively, one camera may be fixed to a camera movement mechanism or a hand tip of the robot to estimate the depth of the characteristic point on the two-dimensional camera image based on a positional deviation (parallax) among the characteristic points on a plurality of two-dimensional camera images different in viewpoint that are captured from the different distances and angles. Alternatively, the workpiece may be placed in a particular background containing a pattern for identifying a three-dimensional position to estimate the depth of the workpiece actually shown in the image using the deep learning with respect to a large amount of two-dimensional camera images captured while changing the distance to the workpiece and the viewpoint.

The teaching unit 52 is configured to cause the display device 30 to display the two-dimensional camera image acquired by the acquisition unit 51, and to allow the user to teach, by using the input device 40, a two-dimensional picking position or a picking position with the depth information of a target workpiece Wo to be picked from among a plurality of workpieces W on the two-dimensional camera image.

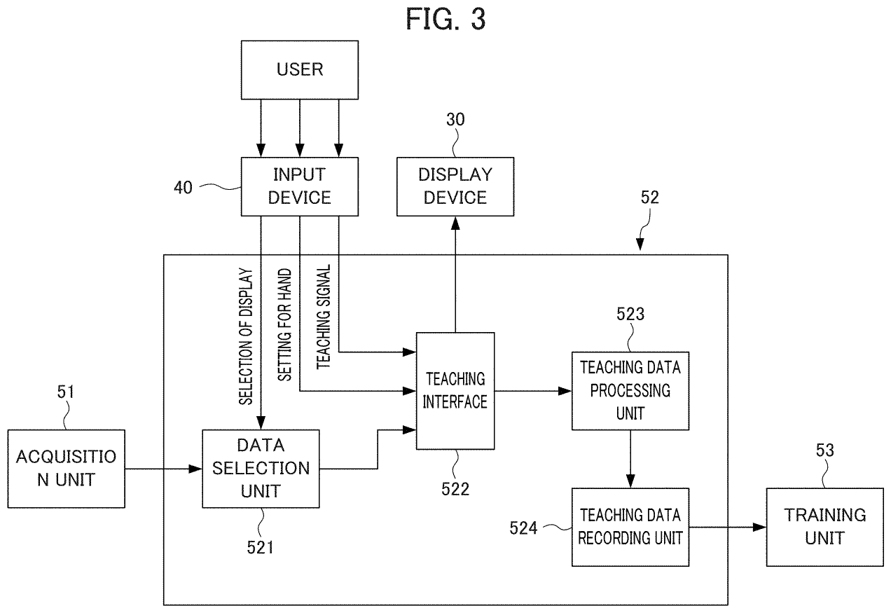

As illustrated in FIG. 3, the teaching unit 52 may include a data selection unit 521 configured to select, from the data acquired by the acquisition unit 51, the two-and-a-half dimensional image data or the two-dimensional camera image with which the user performs the teaching operation via the input device 40, a teaching interface 522 configured to manage transmission and reception of the information between the display device 30 and the input device 40, a teaching data processing unit 523 configured to process the information input by the user to generate teaching data available for the training unit 53, and a teaching data recording unit 524 configured to record the teaching data generated by the teaching data processing unit 523. Note that the teaching data recording unit 524 is not an element essential for the teaching unit 52. For example, a storage unit of an external computer, storage, server or the like may be used for storage.

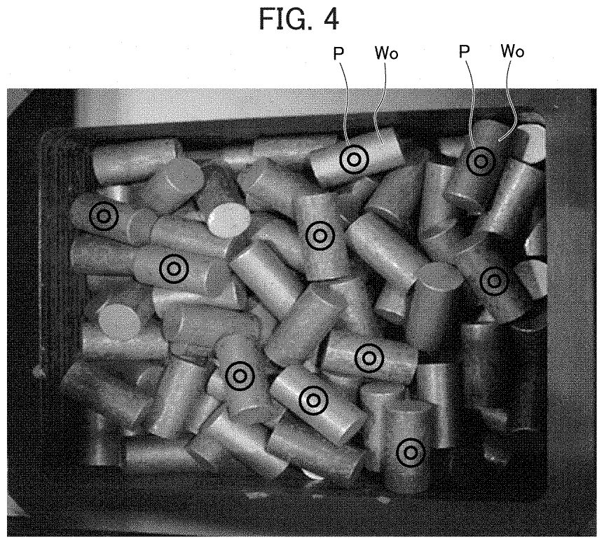

FIG. 4 illustrates an example of a two-dimensional camera image displayed on the display device 30. FIG. 4 illustrates an image showing the container C in which columnar workpieces W are randomly accommodated. The two-dimensional camera image can be easily acquired (an acquisition device is inexpensive), and is hard to cause data missing (pixels whose values cannot be identified) like the depth image. Furthermore, the two-dimensional camera image is similar to an image when the user directly views the workpieces W. Therefore, the teaching unit 52 causes the user to input a teaching position on the two-dimensional camera image, which makes it possible to teach the target workpiece Wo while sufficiently utilizing the knowledge of the user.

The teaching unit 52 may be configured to allow a plurality of teaching positions to be input on one two-dimensional camera image. Thus, the teaching is efficiently performed, which can cause the picking system 1 to learn picking of the appropriate workpiece W in a short time. Furthermore, in the case where the above-described plurality of kinds of workpieces coexist, the workpieces may be classified according to the nature of the plurality of teaching positions that have been taught, for example, by drawing different marks on different kinds of workpieces, and may be displayed. This enables the user to visually check and grasp the kinds of workpieces where the number of teachings is insufficient, which can prevent insufficient training due to insufficient number of teachings.

The teaching unit 52 may display the two-dimensional camera image captured in real time. The teaching unit 52 may read out the two-dimensional camera image captured in the past and stored in a memory device, to display it. The teaching unit 52 may be configured so that the user can input a teaching position on the two-dimensional camera image captured in the past. A plurality of two-dimensional camera images previously captured may be registered with the database. The teaching unit 52 can select the two-dimensional camera image for use in teaching from the database, and furthermore, can register the teaching data containing the taught teaching position with the database. Registering the teaching data with the database makes it possible to share the teaching data among a plurality of robots installed at different places in the world, thereby more efficiently performing the teaching. By performing the teaching without actually executing a picking operation of the robot 20, a wasteful task of executing a picking operation with a high failure rate over a long adjustment time period becomes unnecessary with respect to a workpiece W difficult to create a vision program for performing an appropriate picking operation and adjust the image processing parameter. For example, in the case where a collision is likely to occur between the picking hand 21 and the wall of the container C, teaching is performed not to pick a workpiece at a position close to the container wall, for example, whereby a picking condition that the workpiece W can be reliably picked can be taught.

The user selects a workpiece W to be preferentially picked, as the target workpiece Wo, based on the user's findings, and teaches, as the teaching position, a picking reference position of the picking hand 21 which can hold the target workpiece Wo. Specifically, the user preferably selects, as the target workpiece Wo, a workpiece W with a high degree of exposure such as a workpiece W which is not overlapped by the other workpieces W, and a workpiece W with a shallow depth (positioned above the other workpieces W). In the case where the picking hand 21 has the suction pad 211, the user preferably selects, as the target workpiece Wo, a workpiece W whose portion having a larger flat surface appears on the two-dimensional camera image. The suction pad 211 having contacted such a large plane of the workpiece can reliably suction and pick the workpiece while easily maintaining the air tightness. In the case where the picking hand 21 grips the workpiece W by a pair of gripping fingers 212, the user preferably selects, as the target workpiece Wo, a workpiece at a position where the other workpieces W and any obstacle are not present in spaces at both sides of the picking hand 21 in which the gripping fingers 212 are to be arranged. In the case where the workpiece W is gripped at an interval of the pair of gripping fingers 212 displayed on the image, the user preferably selects, as the target workpiece Wo, a workpiece in which a contact portion having a larger contact area between the gripping fingers and the workpiece is exposed.

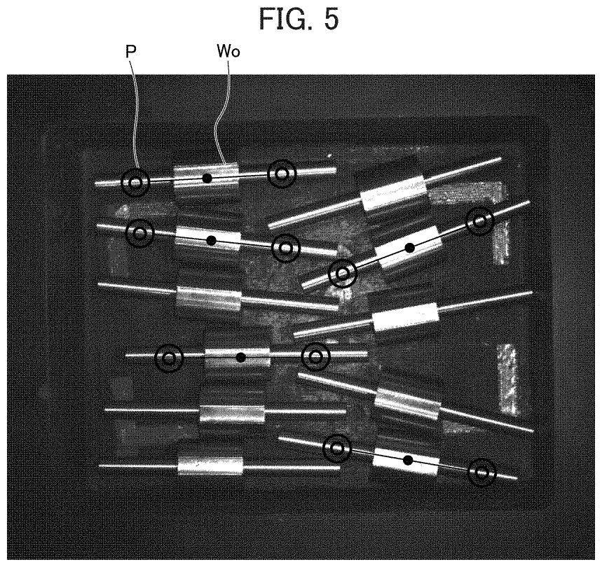

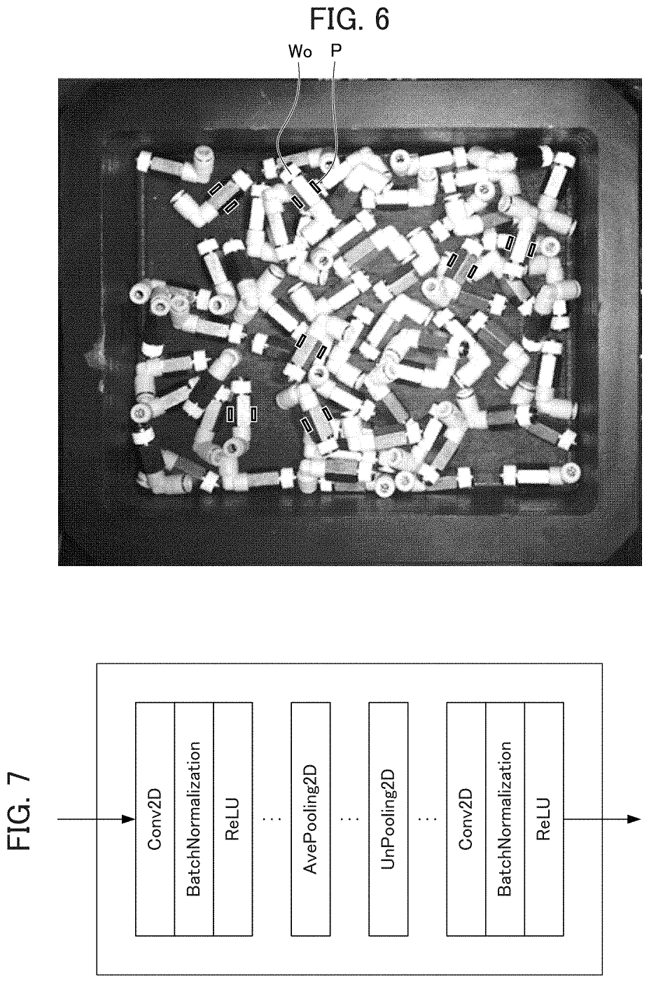

The teaching unit 52 may be configured to allow the user to teach a teaching position using the above-described virtual hand P. This enables the user to easily recognize an appropriate teaching position at which the target workpiece Wo can be held by the picking hand 21. Specifically, as illustrated in FIG. 4, the virtual hand P may have concentric circles imitating an outer profile of the suction pad 211 and an air flow channel for suction at a center of the suction pad 211. Alternatively, in the case where the picking hand 21 has a plurality of suction pads 211, the virtual hand P may have a plurality of forms, each imitating an outer profile of each suction pad 211 and an air flow channel for suction at a center of each suction pad 211, as illustrated in FIG. 5. In the case where the picking hand 21 has a pair of gripping fingers 212, the virtual hand P has a pair of rectangular forms, each indicating an outer profile of the gripping finger 212, as illustrated in FIG. 6.

The virtual hand P may display the picking hand 21 while reflecting the characteristics of the picking hand 21 so that the picking is likely to succeed. For example, in the case where a workpiece is suctioned by the suction pad 211 to be picked, the suction pad 211 which is a portion to contact the workpiece can be displayed as two concentric circles (see FIG. 4) on the two-dimensional image. The inner circle represents an air flow channel, and the user performs teaching while visually checking that a hole, a step, or a groove on the workpiece is not present in a zone in which the inner circle overlaps on the workpiece, to maintain the air tightness required for the success of picking, whereby the user can perform the correct teaching so as to improve success rate of picking. The outer circle represents the outermost boundary line of the suction pad 211, and the user teaches, as the teaching position, a position where the outer circle does not interfere with the surrounding environment (such as the adjacent workpiece, the container wall, or the like), whereby the picking hand 21 can pick the workpiece without interfering with the surrounding environment during the picking operation. Furthermore, when the two-dimensional image is displayed while changing the sizes of the concentric circles according to the depth information for each pixel in the two-dimensional image, more accurate teaching can be performed according to actual ratio between the workpiece and the suction pad 211 in the real world.

The teaching unit 52 may be configured to allow the user to teach a two-dimensional picking posture (two-dimensional posture) of the picking hand 21. As illustrated in FIGS. 5 and 6, in the case where portions of the picking hand 21 to contact the target workpiece Wo have an orientation such as in the case where the picking hand 21 has a plurality of suction pads 211 or in the case where the picking hand 21 has a pair of gripping fingers 212, it is preferable to be able to teach the two-dimensional angle (two-dimensional picking posture of the picking hand 21) of the virtual hand P to be displayed. To thus adjust the two-dimensional angle of the virtual hand P, the virtual hand P may have a handle for adjusting an angle or may have an arrow indicating an orientation of the picking hand 21 (e.g., an arrow indicating the longitudinal direction from a center position). An angle (two-dimensional posture) formed between such a handle or arrow and the longitudinal direction of the target workpiece Wo may be displayed in real time, so that the teaching may be performed. By using the input device 40, the user turns the handle or arrow to a desirable angle, for example, by moving the mouse while pressing the right button of the mouse, and clicking on the left button of the mouse at the desirable angle such that the longitudinal direction of the picking hand 21 is aligned with the longitudinal direction of the target workpiece Wo, so that the desirable angle may be taught. By allowing the two-dimensional angle of the virtual hand P to be taught in this manner, even when the workpiece W having an orientation is arranged at any orientation, the picking hand 21 is aligned with the orientation of the workpiece W, to pick the workpiece held in a balanced state while maintaining the air tightness required for the air suction, whereby the workpiece W can be reliably picked.

The example illustrated in FIG. 5 is an example in which a workpiece W which is an elongated rotary shaft made of iron is suctioned and picked using the picking hand 21 having the two suction pads 211, the rotary shaft having a groove present in a thick portion in the middle. In this example, to pick the long workpiece in a balanced manner, the two suction pads 211 contacts at respective positions of about ⅓ and ⅔ in the longitudinal direction of the workpiece W, whereby the workpiece W can be reliably held and picked without collapsing the balance and dropping when being lifted. When the teaching is performed, for example, a center position of the picking may be taught by arranging a center position of the two suction pads 211 (a middle point of the straight line connecting the two suction pads 211 is drawn and displayed as a dot, for example) to coincide with a center in the thick portion in the middle part of the rotary shaft to teach a center position of the picking, or a two-dimensional picking posture of the picking hand 21 may be taught so that the longitudinal direction of the picking hand 21 (direction along the straight line connecting the two suction pads 211) is aligned with the longitudinal direction of the workpiece W of the rotary shaft.

In the example illustrated in FIG. 6, the workpiece W is an air joint in which a pipe thread is provided at one end, a tube connection coupler bent at 90⊐ is provided at the other end, and a polygonal-pillar nut portion with which a tool is to be engaged is provided at a middle portion. The example illustrated in FIG. 6 is an example in which the workpiece W is gripped and picked using the picking hand 21 having a pair of gripping fingers 212. In this example, a picking center position of the picking hand 21 is taught so that the picking hand 21 pinches the polygonal-pillar nut portion having the largest flat surface in the workpiece W using the pair of gripping fingers 212 whose pinching sides have flat surfaces. As for the two-dimensional picking posture of the picking hand 21, the two-dimensional angle is taught so that a normal direction of the plane of the nut portion to contact the picking hand 21 is aligned with the opening and closing direction of the pair of gripping fingers 212, whereby larger flat contact can be obtained and a larger friction force can be generated without causing extra two-dimensional rotational motion of the target workpiece Wo upon contact, so that the workpiece W can be reliably held with a stronger gripping force.

In this way, in the teaching unit 52, the user can position the virtual hand P reflecting the two-dimensional shape and size of the pair of gripping fingers 212 or the plurality of suction pads 211, the orientation (e.g., the longitudinal direction, or the opening and closing direction) and the center position of the hand, and the interval of the plurality of pads or the fingers, at a position where the actual suction pads 211 or gripping fingers 212 are to be arranged with respect to the target workpiece Wo, and can teach the teaching position. This enables the user to simultaneously teach the picking position of the picking hand 21 and the two-dimensional picking posture (a rotation angle of the two-dimensional camera image in the image plane) of the picking hand 21 which can appropriately hold the target workpiece Wo.

The teaching unit 52 may be configured to allow a user to teach the order for picking a plurality of target workpieces Wo. The depth information contained in the two-and-a-half dimensional image data acquired by the information acquisition device 10 is displayed on the display device 30, so that the order for picking the workpieces may be taught. For example, the depth information corresponding to each pixel in the two-dimensional camera image, the pixel being pointed by the virtual hand P, is acquired from the two-and-a-half dimensional image data, and a value of the depth is displayed in real time, whereby it can be determined which workpiece is positioned on an upper side and which workpiece is positioned on a lower side among the plurality of neighboring workpieces. The user checks and numerically compares values of the depths while moving the virtual hand P to respective pixel positions, which enables the user to teach the order for picking the workpieces so that the workpiece positioned on the upper side can be preferentially picked. Alternatively, the user may visually check the two-dimensional camera image and teach the order for picking the workpieces so that the workpiece W with a high degree of exposure and without being overlapped by the surrounding workpieces can be preferentially picked, or may teach the order for picking the workpieces so that the workpiece W having a smaller value of the displayed depth (positioned higher) and with a higher degree of exposure can be preferentially picked.

The teaching unit 52 may be configured to allow the user to teach an operation parameter of the picking hand 21. For example, in the case where the number of contact positions between the picking hand 21 and the target workpiece Wo is two or more, the teaching unit 52 may be configured to allow the user to teach the opening and closing degree of the picking hand 21. Examples of the operation parameter of the picking hand 21 include an interval of a pair of gripping fingers 212 (the opening and closing degree of the picking hand 21) in the case where the picking hand 21 has the pair of gripping fingers 212. When the picking position of the picking hand 21 with respect to the target workpiece Wo is determined, a space for inserting the gripping fingers 212 required at both sides of the target workpiece Wo can be reduced by setting the interval of the pair of gripping fingers 212 to a value slightly larger than the width of the portion where the workpiece W is pinched, whereby the number of workpieces W capable of being picked by the picking hand 21 can be increased. In addition, in the case where a plurality of zones in which the workpiece W can be stably gripped are present on the workpiece W, it is preferable to teach different opening and closing degrees in correspondence with the widths of the respective zones on the workpiece W. This enables the number of workpieces W capable of being picked by the picking hand 21 to be increased in various states in which the workpieces overlap with each other by gripping another exposed zone capable of being gripped, even when one zone capable of being gripped is overlapped by the surrounding workpieces and is not exposed, for example. In the case where a plurality of candidate zones capable of being gripped are simultaneously found in the same target workpiece Wo, the depth information of the center positions of the candidate zones is used to determine the candidate zone positioned at the uppermost position as a target to be preferentially gripped, which makes it possible to reduce the risk of causing failure due to overlapping by the surrounding workpieces to pick the workpiece. Alternatively, with respect to a plurality of kinds of workpieces, different opening and closing degrees are taught in correspondence with the widths of the zones capable of being gripped on the respective workpieces, whereby the appropriate gripping zone on each workpiece can be gripped with an appropriate opening and closing degree to pick the workpiece. The operation parameter may be set by directly inputting a numerical value, but may be set by adjusting a position of a bar displayed on the display device 30, which enables the user to intuitively set the operation parameter.

In the case where the picking hand 21 is a gripping hand, the teaching unit 52 may be configured to allow the user to teach a gripping force of the gripping fingers. In the case where a sensor for detecting the gripping force of the gripping fingers, or the like is not provided, the teaching unit 52 may allow the user to teach the opening and closing degree of the picking hand 21, and estimate and teach the gripping force based on the correspondence relationship between the opening and closing degree estimated previously and the gripping force. The opening and closing degree of the pair of gripping fingers 212 (interval of the fingers) upon gripping is displayed on the display device 30, and the opening and closing degree of the gripping fingers 212 displayed via the input device 40 is adjusted, and is relatively compared with the width of the portion to be gripped of the target workpiece Wo, whereby the adjusted opening and closing degree (i.e., interval of the gripping fingers 212 upon gripping) can be used as an index obtained by visualizing the strength of the gripping force of the picking hand 21 gripping the target workpiece Wo. Specifically, as the theoretical interval of the pair of gripping fingers 212 upon gripping is smaller than the width of the portion to be gripped on the workpiece, the picking hand 21 grips so strongly as to deform the workpiece W after contacting the workpiece W, and therefore it means that the gripping force of the picking hand 21 is increased. More specifically, a difference (hereinafter, referred to as an “amount of overlap”) between the theoretical interval of the gripping fingers 212 and a normal width of the portion to be gripped of the workpiece W is absorbed by elastic deformation of the gripping fingers 212 and the workpiece W, and the elastic force of the elastic deformation acts as a gripping force with respect to the target workpiece Wo. When the gripping force when the amount of overlap is not a positive value is displayed as zero, this means that the gripping fingers 212 and the workpiece W have not contacted each other yet or are brought into light point contact with each other such that a force is not transmitted. Since the user can visually check the display value of the gripping force, the workpiece W can be prevented from dropping due to insufficient gripping force. As for the different materials, the correspondence relationship between the amount of overlap and the strength of the gripping force is estimated from the data collected through preliminary experiments and is stored as the database, whereby when the user specifies the theoretical interval, the estimated value of the strength of the gripping force corresponding to the amount of overlap can be read from the database and displayed on the teaching unit 52. Accordingly, the user specifies the theoretical interval of the gripping fingers 212 in consideration of the materials and sizes of the workpiece W and the gripping fingers 212, whereby the picking hand 21 can hold the workpiece W with an appropriate griping force without crushing and dropping the workpiece W.

In the case where the picking hand 21 is a gripping hand, the teaching unit 52 may be configured to allow the user to teach a gripping stability of the gripping hand. The teaching unit 52 analyzes, using a coulomb friction model, a friction force acting between the gripping fingers 212 and the target workpiece Wo upon contact therebetween, and causes the display device 30 to graphically and numerically display the analysis results of the index representing the gripping stability defined based on the coulomb friction model. The user can adjust the picking position and the two-dimensional picking posture of the picking hand 21 while visually checking the results, and can perform the teaching to obtain higher gripping stability.

There are very many common points between a method of using the teaching unit 52 to teach the gripping stability on the two-dimensional camera image and a method of teaching the gripping stability on the three-dimensional point cloud data described in a second embodiment, which will be described later, and hence redundant description is not repeated and only different points are described.

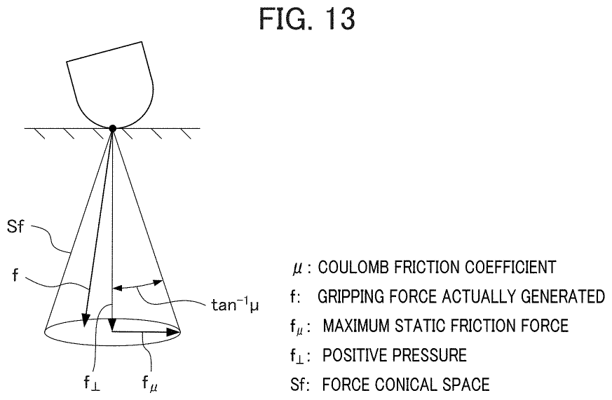

A coulomb friction model illustrated in FIG. 13 is three-dimensionally described, and in this case, a desirable contact force not causing slippage between the gripping fingers 212 and the target workpiece Wo is in the three-dimensional conical space illustrated in the figure. In the case where the gripping stability is taught in the two-dimensional image, the desirable contact force not causing slippage between the gripping fingers 212 and the target workpiece Wo can be represented as being in a two-dimensional triangular area obtained by projecting the above-described three-dimensional conical space on the image plane which is a two-dimensional plane.

Using the coulomb friction model thus two-dimensionally described, in the two-dimensional image, a candidate group of the desirable contact forces f not causing slippage between the gripping fingers 212 and the target workpiece Wo is a two-dimensional triangular two-dimensional space (force triangular space) Af in which a maximum value of a vertex does not exceed 2 tan⁻¹⊐, based on a coulomb friction coefficient □ and a positive pressure f_{□}. The contact force for stably gripping the target workpiece Wo without causing slippage needs to be present inside the force triangular space Af. Since one moment around a center of gravity of the target workpiece Wo is generated by any one contact force f in the force triangle shaped space Af, there is present a triangular space of the moment (moment triangular space) Am corresponding to the force triangular space Af of the desirable contact force. Such a desirable moment triangular space Am is defined based on the coulomb friction coefficient □, the positive pressure f_{□}, and a distance from the center of gravity G of the target workpiece Wo to each contact position.

To stably grip the target workpiece Wo without causing slippage and without dropping the target workpiece Wo, each contact force at each contact position needs to be present inside the corresponding force triangular space Afi (i=1, 2, or the like, i is the total number of contact positions), and each moment around the center of gravity of the target workpiece Wo which is generated by each contact force needs to be present in the corresponding moment triangular space Ami (i=1, 2, or the like, i is the total number of contact positions). Accordingly, a two-dimensional minimum convex hull (minimum convex envelop shape containing all) Hf containing all of the force triangular spaces Afi at the plurality of contact positions is a stable candidate group of the desirable forces for stably gripping the target workpiece Wo without causing slippage, and the two-dimensional minimum convex hull Hm containing all of the moment triangular spaces AMi at the plurality of contact positions is a stable candidate group of the desirable moments for stably gripping the target workpiece Wo without causing slippage. That is, in the case where the center of gravity G of the target workpiece Wo is present in the minimum convex hulls Hf and Hm, the contact force generated between the gripping fingers 212 and the target workpiece Wo is included in the above-described force stable candidate group, and the generated moment around the center of gravity of the target workpiece Wo is included in the above-described moment stable candidate group, and therefore such gripping is achieved with preventing the position and posture of the target workpiece Wo from changing from the initial position upon capturing the image due to slippage, with preventing the target workpiece Wo from dropping due to slippage, and without causing the unintentional rotational motion around the center of gravity of the target workpiece Wo, whereby the gripping can be determined to be stable.

In the analysis using the coulomb friction model projected on the two-dimensional image plane and two-dimensionally described, the volumes of the above-described minimum convex hulls Hf and Hm can be obtained, in the two-dimensional image, as areas of the two different two-dimensional convex spaces. Since as the area is increased, the center of gravity G of the target workpiece Wo is more easily contained in the area, the number of candidates of the forces and the moments for stable gripping is increased, whereby the gripping stability can be determined to be high.

As a specific determination index, the gripping stability evaluation value Qo=W₁₁ε+W₁₂V can be used as an example. Here, ⊐ is a shortest distance from the center of gravity G of the target workpiece Wo to the boundary of the minimum convex hull Hf or Hm (a shortest distance □_{f} to the boundary of the minimum convex hull Hf of the force or a shortest distance □ₘ to the boundary of the minimum convex hull Hm of the moment), V is a volume of the minimum convex hull Hf or Hm (an area A_{f} of the minimum convex hull Hf of the force or an area Aₘ of the minimum convex hull Hm of the moment), and W₁₁ and W₁₂ are constants. Qo defined in this way can be used regardless of the number of gripping fingers 212 (the number of contact positions).

In this way, in the teaching unit 52, the index representing the gripping stability is defined using at least one of the volume of the minimum convex hull Hf or Hm calculated using at least one of a plurality of contact positions of the virtual hand P with respect to the target workpiece Wo and a friction coefficient between the picking hand 21 and the target workpiece Wo at each contact position, and the shortest distance from the center of gravity G of the target workpiece Wo to the boundary of the minimum convex hull.

The teaching unit 52 causes the display device 30 to numerically display the calculation result of the gripping stability evaluation value Qo when the user temporarily inputs the picking position and the posture of the picking hand 21. The user can check whether the gripping stability evaluation value Qo is appropriate as compared to a threshold displayed simultaneously. The teaching unit 52 may be configured to select whether temporarily input picking position and posture of the picking hand 21 are determined as the teaching data or the picking position and the posture of the picking hand 21 are corrected and input again. In addition, the teaching unit 52 may be configured to intuitively facilitate the optimization of the teaching data so as to satisfy the threshold by graphically displaying, on the display device 30, the volume V of the minimum convex hull Hf or Hm and the shortest distance □ from the center of gravity G of the target workpiece Wo.

The teaching unit 52 may be configured to display the two-dimensional camera image showing the workpieces W and the container C and display the picking position and picking posture taught by the user, thereby graphically and numerically displaying the calculated minimum convex hulls Hf and Hm, volume, and shortest distance and presenting the volume and the threshold of the shortest distance for stable gripping, to display the determination result of the gripping stability. This enables the user to visually check whether the center of gravity G of the target workpiece Wo is inside the Hf and Hm. In the case where it is found that the center of gravity G is outside the Hf and Hm, the user changes the teaching position and the teaching posture and clicks on a recalculation button, so that the minimum convex hulls Hf and Hm reflecting the new teaching position and teaching posture are graphically updated and reflected. By repeating such an operation several times, the user can teach the desirable position and posture such that the center of gravity G of the target workpiece Wo is inside the Hf and Hm while visually checking whether the center of gravity G of the target workpiece Wo is inside the Hf and Hm. The user changes the teaching position and the teaching posture as needed while checking the determination results of the gripping stability, thereby making it possible to perform the teaching to obtain higher gripping stability.

The teaching unit 52 may be configured to allow the user to teach the picking position of the workpiece W based on CAD model information of the workpiece W. For example, the teaching unit 52 acquires the characteristics including a hole or a groove, a plane and the like of the workpiece W shown in the two-dimensional image by image pre-processing, finds the same characteristics on the three-dimensional CAD model of the workpiece W, projects the three-dimensional CAD model with the characteristics in the center on the characteristic plane of the workpiece (a plane including a hole or a groove on the workpiece or a plane itself on the workpiece) to check the generated two-dimensional CAD drawing with the image in the proximity of the same characteristics on the two-dimensional image, and dispose the two-dimensional CAD drawing to match the peripheral image. Therefore, even when the two-dimensional image including a partial area which is not focus due to misadjustment of the information acquisition device 10 or is not clearly visible due to too bright or too dark illumination is acquired, the information of the area which is not clearly visible is interpolated from the CAD data and is displayed by matching the characteristics (e.g., a hole or a groove, a plane, and the like) present in another area which is clearly shown, with the CAD data by the above-described method, which enables the user to easily teach the interpolated complete data while visually checking it. Alternatively, the teaching unit 52 may be configured to analyze the friction force acting between the gripping fingers 212 of the picking hand 21 and the workpiece based on the two-dimensional CAD drawing disposed to match the two-dimensional image. This can prevent the user from performing erroneous teaching causing a wrong orientation of the contact surface of gripping due to the two-dimensional image including blur, unstable picking with an edge pinched, or picking performed by suctioning characteristic portion such as a hole, thereby enabling the correct teaching.

In the case where the two-dimensional picking posture and the like are also taught, the teaching unit 52 may be configured to teach a two-dimensional picking posture for the workpiece W based on the CAD model information of the workpiece W. For example, the teaching mistake of the two-dimensional picking posture for the symmetrical workpiece can be eliminated and the teaching mistake caused by the two-dimensional image in which blur is present in a partial area can be eliminated, based on the two-dimensional CAD drawing disposed to match the two-dimensional image using a method of matching the CAD data of the above-described workpiece W.

The training unit 53 generates a trained model for inferring a two-dimensional picking position of the target workpiece Wo using the two-dimensional camera image as input data by machine learning (supervised learning) based on training input data obtained by adding, to the two-dimensional camera image, the teaching data including the two-dimensional picking position which is a teaching position. Specifically, the training unit 53 uses a convolutional neural network to generate the trained model for quantifying and determining the commonality between the camera image of the peripheral zone of each pixel and the camera image of the peripheral zone of the teaching position in the two-dimensional camera image, more highly evaluate, with higher score, the pixel with higher commonality with the teaching position, and infer such a pixel as a target position to which the picking hand 21 should go for more preferential picking.

The training unit 53 may be configured to generate a trained model for inferring a picking position with the depth information of the target workpiece Wo using the two-and-a-half dimensional image data as input data by machine learning (supervised learning) based on training input data obtained by adding, to the two-and-a-half dimensional image data (data including a two-dimensional camera image and depth information for each pixel of the two-dimensional camera image), the teaching data including the picking position with the depth information which is a teaching position. Specifically, the training unit 53 uses the convolutional neural network to establish a rule A for quantifying and determining the commonality between the camera image of the peripheral zone of each pixel and the camera image of the peripheral zone of the teaching position in the two-dimensional camera image, and further uses another convolutional neural network to establish a rule B for quantifying and determining the commonality between the depth image of the peripheral zone of each pixel and the depth image of the peripheral zone of the teaching position in the depth image converted from the depth information for each pixel, and more highly evaluate, with higher score, the picking position with the depth information with higher commonality with the teaching position comprehensively determined by the rule A and the rule B, so that such a picking position may be inferred as a target position to which the picking hand 21 should go for more preferential picking.

In the case where the two-dimensional angle (two-dimensional picking posture of the picking hand 21) of the virtual hand P indicating the picking hand 21 is further taught in the teaching unit 52, the training unit 53 generates a trained model for also inferring a two-dimensional angle (two-dimensional picking posture) of the picking hand 21 when picking the workpiece Wo, in addition to the taught two-dimensional angle (two-dimensional picking posture of the picking hand 21) of the virtual hand P.

The training unit 53 may generate a trained model, as training input data, for inferring a two-dimensional picking center position and a two-dimensional picking posture using the two-dimensional camera image as input data, the training input data being obtained by adding, to the two-dimensional camera image, the teaching data including the teaching position (two-dimensional picking center position of the picking hand 21, for example, a center position of the straight line connecting the two suction pads 211, or a center position of the straight line connecting fingers of the pair of gripping fingers 212) and the teaching posture (two-dimensional picking posture of the picking hand 21). As one implementation, the taught two-dimensional picking center position is referred to as a center position, from the two-dimensional picking teaching posture at the center position, the training unit 53 calculates a two-dimensional position of a location away from the center position by the unit length (e.g., a value of ½ of the interval between the two suction pads 211 or between the pair of gripping fingers 212), and defines the calculated two-dimensional position as a second teaching position. In this way, an issue of inferring the two-dimensional picking center position and the two-dimensional picking posture based on the two-dimensional camera image, using the two-dimensional camera image, the teaching position, and the teaching posture as the training input data can be equivalently converted into an issue of inferring the two-dimensional picking center position and the peripheral second two-dimensional picking position which is away from the two-dimensional picking center position by the unit length, using the two-dimensional camera image, the teaching position, and the second teaching position as the training input data. The trained model for inferring a two-dimensional picking center position based on the two-dimensional camera image can be generated in the same manner as described above. To infer the second two-dimensional position based on the two-dimensional camera image, one second two-dimensional position is inferred from among a plurality of two-dimensional position candidates distributed over 360 degrees on a circle having a radius equal to the unit length and centered on the teaching position in the image of a square-shaped zone in the proximity of the teaching position, the square-shaped zone having a length of one side which is equivalent to four times of the unit length and is centered on the teaching position. The trained model is generated by training the relationship between the teaching position as the center of the square-shaped zone and the second teaching position based on the image of the square-shaped zone, using another convolutional neural network.

The training unit 53 may generate a trained model, as training input data, for inferring a picking position with the depth information and a two-dimensional picking posture based on the two-and-a-half dimensional image data, the training input data being obtained by adding, to the two-and-a-half dimensional image data (data including a two-dimensional camera image and depth information for each pixel of the two-dimensional camera image), the teaching data including the teaching position (picking position with the depth information) and the teaching posture (two-dimensional picking posture of the picking hand 21). Specifically, a trained model may be generated by a combination of the above-described methods.

The structure of the convolutional neural network of the training unit 53 may include a plurality of layers such as Conv2D (2D convolutional operation), AvePooling2D (2D average pooling operation), UnPooling2D (2D pooling inverse operation), Batch Normalization (function that maintains normalization of the data), ReLU (activation function that prevents a vanishing gradient problem), and the like, as illustrated in FIG. 7. In such a convolutional neural network, the dimensionality of the two-dimensional camera image to be input is reduced to extract necessary characteristic map, the dimensionality of the input image is further returned to the original dimensionality to predict the evaluation score for each pixel in the input image, and the predicted value is output in full size. While maintaining the normalization of the data and preventing the vanishing gradient problem, a weighting coefficient of each layer is updated and determined by training so that a difference between the output predicted data and the teaching data decreases gradually. This enables the training unit 53 to generate the trained model so as to evenly search for all the pixels in the input image as candidates, calculate all the predicted scores in full size at once, and obtain, from the candidates, a candidate position with high commonality with the teaching position and with a high possibility of enabling picking to be performed by the picking hand 21. By thus inputting the image in full size and outputting the predicted scores of all the pixels in the image in full size, most appropriate candidate positions can be found without fail. This can prevent a problem in that the most appropriate candidate positions cannot be found if a method of cutting out the image is worse than the training method that requires pre-processing of cutting out a part of the image due to unpredictability in full size. The depth and complexity of the specific convolutional neural network may be adjusted according to the size of the input two-dimensional camera image and the workpiece shape complexity.

The training unit 53 may be configured to determine whether the result of training by machine learning based on the above-described training input data is acceptable or not acceptable, and to display the determination result on the above-described teaching unit 52, and further to display, on the above-described teaching unit 52, a plurality of training parameters and adjustment hints when the determination result indicates that the result of training is not acceptable, and to enable the user to adjust the training parameters and perform retraining. For example, the training unit 53 may display the transition diagram and the distribution diagram of the training accuracy with respect to the training input data and the test data, and determine the determination result to be not accepted in the case where the training accuracy is not enhanced or is lower than a threshold even when the training progresses. The training unit 53 may calculate accuracy, recall, precision, or the like with respect to the teaching data which is a part of the above-described training input data, so as to determine whether the result of training by the training unit 53 is acceptable or not acceptable, by evaluating whether the prediction can be performed as taught by the user, whether an inappropriate position not taught by the user is erroneously predicted as an appropriate position, how much the know-how taught by the user can be recalled, and how much the trained model generated by the training unit 53 is adapted to the picking of the target workpiece Wo. The training unit 53 displays, on the teaching unit 52, the above-described transition drawing, distribution drawing, the calculated value of the accuracy, recall, or precision, which represent the training result, and the determination result, and the plurality of training parameters when the determination result is rejected, and further displays, on the teaching unit 52, the adjustment hints for enhancing the training accuracy and obtaining high accuracy, recall or precision, to present the adjustment hints to the user. The user can adjust the training parameters based on the presented adjustment hints and perform the re-training. In this way, the determination result of the result of training by the training unit 53 and the adjustment hints are presented to the user even when the picking experiment is not actually performed, which makes it possible to generate the trained model with high reliability in a short time.

The training unit 53 may feed not only the teaching position taught by the teaching unit 52 but also the inference result of the picking position inferred by the inference unit 54, which will be described later, back to the above-described training input data, and perform the machine learning based on the changed training input data to adjust the trained model for inferring a picking position of the target workpiece Wo. For example, the training unit 53 may correct the above-described training input data to exclude, from the teaching data, the picking position with low evaluation score among the results of inference by the inference unit 54, and perform the machine learning again based on the corrected training input data to adjust the trained model. In addition, the training unit 53 may analyze the characteristics at the picking position with high evaluation score among the results of inference by the inference unit 54, and automatically assign a label, by internal processing, to define, as the teaching position, a pixel with high commonality with the inferred picking position with high evaluation score, although being not taught by the user on the two-dimensional camera image. This enables the training unit 53 to correct the erroneous determination of the user and generate the trained model with higher accuracy.

In the case where the two-dimensional picking posture and the like are further taught by the teaching unit 52, the training unit 53 may feed the result of inference further including the two-dimensional picking posture inferred by the inference unit 54, which will not described layer, back to the above-described training input data, and perform the machine learning based on the changed training input data to adjust the trained model for inferring a two-dimensional picking posture for the target workpiece Wo based on the changed training input data. For example, the training unit 53 may correct the above-described training input data to exclude, from the teaching data, the two-dimensional picking posture with low evaluation score among the results of inference by the inference unit 54, and perform the machine learning again based on the corrected training input data to adjust the trained model. In addition, the training unit 53 may analyze the characteristics of the two-dimensional picking posture with high evaluation score among the results of inference by the inference unit 54, and automatically assign a label by internal processing to add, to the teaching data, the two-dimensional picking posture with high commonality with the inferred picking posture with high evaluation score, although being not taught by the user on the two-dimensional camera image.

The training unit 53 may perform the machine learning by adding, to the training input data, not only the teaching position taught by the teaching unit 52 but also the control result of the picking operation of the robot 20 by the control unit 55 based on the picking position inferred by the inference unit 54, which will be described later, i.e., the information about the result as to whether the picking operation of the target workpiece Wo performed using the robot 20 has succeeded, and may generate a trained model for inferring a picking position of the target workpiece Wo. Therefore, even when more erroneous teaching positions are included in a plurality of teaching positions taught by the user, the training unit 53 performs the retraining based on the result of the actual picking operation, and corrects the erroneous determination of the user, which makes it possible to generate the trained model with higher accuracy. This function makes it possible to generate the trained model by automatic training without prior teaching by the user, using the result as to whether the operation of going to the picking position randomly determined for picking has succeeded.

In a situation in which the workpieces are left in the container C after the target workpieces Wo are picked using the robot 20 by the control unit 55 based on the picking positions inferred by the inference unit 54, which will be described later, the training unit 53 may be configured to also learn such a situation to adjust the trained model. Specifically, the image data when the workpieces W are left in the container C is displayed on the teaching unit 52, which enables the user to additionally teach the picking positions. In this way, one image showing the left workpieces W may be taught, but a plurality of images may be displayed. The data thus additionally taught is also input to the training input data, and the retraining is performed to generate the trained model. A state in which the number of workpieces in the container C decreases as the picking operation progresses, making it difficult to pick the workpieces, for example, a state in which the workpieces present near the wall side and corner side of the container C are left easily occurs. Alternatively, in the state in which the left workpieces overlap with one another or in the state in which the workpiece is in the posture which makes it difficult to pick the workpiece, for example, when the whole workpiece at the position corresponding to the teaching position is hidden behind the others and the workpiece posture is not captured by the camera or the workpieces overlap with one another, or when the workpiece is captured by the camera but is largely inclined, the hand may interfere with the container C or the other workpieces when the workpiece is picked. It is highly probable that the state in which the left workpieces overlap with one another and the workpiece state cannot be supported by the learned model. At this time, the user performs additional teaching about the other positions which are positioned farther from the wall and the corner, the other positions captured by the camera without being hidden by anything else, or the other positions which are not inclined largely, and inputs the additionally taught data to perform the re-training, whereby this problem can be solved.

In the case where the two-dimensional picking posture and the like are further taught by the teaching unit 52, the training unit 53 may perform the machine learning based on the inference result further including the two-dimensional picking posture inferred by the inference unit 54, which will be described later, and based on the control result of the picking operation of the robot 20 by the control unit 55, i.e., the information about the result as to whether the picking operation of the target workpiece Wo performed using the robot 20 has succeeded, to generate a trained model for further inferring a two-dimensional picking posture for the target workpiece Wo.

The result as to whether the picking of the target workpiece Wo has succeeded may be determined by a detection value of the sensor mounted on the picking hand 21, or may be determined based on a change from presence to absence of the workpiece at the contact portion of the picking hand 21 with the target workpiece Wo on the two-dimensional camera image captured by the information acquisition device 10. In the case where the target workpiece Wo is picked by the picking hand 21 having the suction pads 211, the result as to whether the picking of the target workpiece Wo has succeeded may be determined by detecting a change in a vacuum pressure inside the picking hand 21 by a pressure sensor. In the case of the picking hand 21 having the gripping fingers 212, the result as to whether the picking of the target workpiece Wo has succeeded may be determined by detecting a change from presence to absence of a contact between the fingers and the target workpiece Wo or a change in a contact force or gripping force by a contact sensor or tactile sensor, or a force sensor mounted on the finger. In addition, a value of an opening and closing width of the hand in each of the state of not gripping the workpiece and the state of gripping the workpiece or the maximum value and the minimum value of the opening and closing width of the hand are registered before starting the picking operation, and a change value in encoder value of the drive motor by the opening and closing operation of the hand is detected to compare with the above-described registered value, whereby the result as to whether the picking of the target workpiece Wo has succeeded may be determined. Alternatively, in the case where a magnetic hand is used for holding and picking a workpiece made of iron with a magnetic force, the result as to whether the picking of the target workpiece Wo has succeeded may be determined by detecting a change in a position of the magnet mounted inside the hand by a position sensor.

The inference unit 54 infers at least a more appropriate picking position having high possibility of successful picking, based on the two-dimensional camera image acquired by the acquisition unit 51 and the trained model generated by the training unit 53, and based on the two-dimensional camera image. In the case where the two-dimensional angle (two-dimensional picking posture) of the picking hand 21 is taught, the inference unit 54 further infers a two-dimensional angle (two-dimensional picking posture) of the picking hand 21 when picking the target workpiece Wo based on the trained model.

In the case where the acquisition unit 51 acquires the two-and-a-half dimensional data including the depth information in addition to the two-dimensional camera image, the inference unit 54 infers at least a more appropriate picking position with the depth information having high possibility of successful picking, based on the acquired two-and-a-half dimensional image data and the trained model generated by the training unit 53, and based on the two-and-a-half dimensional image data. In the case where the two-dimensional angle (two-dimensional picking posture) of the picking hand 21 is taught, the inference unit 54 further infers a two-dimensional angle (two-dimensional picking posture) of the picking hand 21 when picking the target workpiece Wo based on the trained model.

In the case where a plurality of picking positions inferred by the inference unit 54 are present on the two-dimensional camera image, an order of priority for picking may be set to the plurality of picking positions. For example, the inference unit 54 may assign a high evaluation score to a picking position with high commonality with an image of the peripheral zone of the teaching position from the image of the peripheral zone of the plurality of picking positions, and may determine that the picking position with a high evaluation score should be preferentially picked. When the image in the proximity of a picking position has higher commonality with the image in the proximity of the teaching position, such a picking position better reflects the findings of a teaching person according to the learned trained model, and therefore the picking position has the highest possibility of successful picking. For example, the picking position having the highest possibility of successful picking is a position with a high degree of exposure where the number of workpieces W overlapping on the target workpiece Wo is small and not including characteristics such as a groove or hole, a step, a recess, and a thread which eliminate the air tightness in a contact zone with the suction pad, or is a position having a large flat surface which is likely to succeed in air suction or magnetic attraction, and therefore the target workpiece Wo which is likely to be picked with fewer failures is inferred to be at such a picking position with high possibility of successful picking determined by the findings of the teaching person.

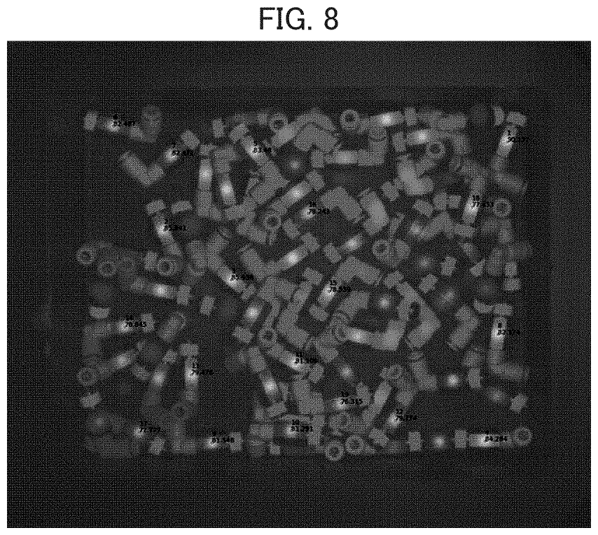

FIG. 8 illustrates an example in which in the case where the workpiece W is an air joint, and the picking hand 21 has one suction pad 211, the commonality with the image in the proximity of the teaching position is scored, and an order of priority is set to the target workpieces Wo corresponding to more appropriate picking positions with a high degree of exposure and not including characteristics such as a groove or hole, a step, a recess, and a thread in proximity, or having a larger flat surface in the peripheral zone. In this case, it is desirable that the suction pad 211 is brought into contact with a center of one plane of a nut in the center of the workpiece W. Accordingly, the user searches for a workpiece W in which a plane of the nut is exposed as clearly as possible, and disposes the virtual hand at the center of the plane of the nut with a high degree of exposure, and teaches the disposed position as a target position. The inference unit 54 infers a plurality of picking positions having the commonality of the image in the proximity of the teaching position, and score the commonality of the image, whereby an order of priority for picking is quantitatively defined. In the figure, scores (e.g., 90.337, 85.991, 85.936, 84.284) which are evaluation scores according to an order of priority (e.g., 1, 2, 3, 4, and the like) are affixed to markers (dots) indicating the picking positions.

The inference unit 54 may set an order of priority for picking to a plurality of target workpieces Wo based on the depth information included in the two-and-a-half dimensional image data acquired by the acquisition unit 51. Specifically, the inference unit 54 may determine that the target workpiece Wo with a shallower depth of the picking position is more easily picked, and is picked at a higher priority order. The inference unit 54 may determine an order of priority for picking of a plurality of target workpieces Wo based on the scores calculated with a weighting coefficient using both of a score set according to the depth of a picking position and a score set according to the commonality of the image in the proximity of the above-described picking position. Alternatively, the inference unit 54 sets a threshold of the score set according to the commonality of the image in the proximity of the above-described picking position, and defines all of the picking positions with commonality with the image exceeding the threshold as the picking positions with high possibility of successful picking determined by the findings of the teaching person, so that from among these picking positions as a more appropriate candidate group, the target workpieces Wo with a shallower depth of the picking position may be preferentially picked.

The control unit 55 controls the robot 20 to pick the target workpiece Wo by the picking hand 21 based on the picking position of the target workpiece Wo. In the case where the acquisition unit 51 acquires only the two-dimensional camera image, with respect to a plurality of workpieces arranged in one layer such that a workpiece does not overlap on another workpiece, for example, the control unit 55 performs calibration of the planes of the workpieces arranged in one layer on the image plane of the two-dimensional camera image and the real space using a calibration jig or the like, calculates a position on the plane of the workpiece on the real space corresponding to each pixel on the image plane, and controls the robot 20 to go for picking. In the case where the acquisition unit 51 further acquires the depth information, the control unit 55 adds the depth information to the two-dimensional picking position inferred by the inference unit 54 or calculates the necessary operation of the robot 20 so that the picking hand 21 goes to the picking position with the depth information inferred by the inference unit 54 for picking, and inputs an operation command to the robot 20.

In the case where the acquisition unit 51 further acquires the depth information, the control unit 55 may be configured to analyze a three-dimensional shape of the target workpiece Wo and the surrounding environment thereof, to incline the picking hand 21 with respect to the image plane of the two-dimensional camera image, and to incline the picking hand 21 in a direction of being inclined with respect to the image plane of the two-dimensional camera image, thereby making it possible to prevent the picking hand 21 from interfering with surrounding workpieces W of the target workpiece Wo.

In the case where the workpiece Wo is held by the suction pad 211, and a contact portion of the target workpiece Wo with the suction pad 211 is inclinedly arranged with respect to the image plane, inclining the picking hand 21 with respect to the image plane so that a suction surface of the suction pad 211 can face the contact surface of the target workpiece Wo allows the target workpiece Wo to be reliably suctioned. In this case, assuming that a reference point of the picking hand 21 is present on the suction surface of the suction pad 211, the picking hand 21 is inclined not to deviate from the reference point, which makes it possible to compensate the posture of the picking hand 21 with respect to the inclined target workpiece Wo. In this way, as a method of three-dimensionally compensating the picking posture, one three-dimensional plane may be estimated, with respect to a desirable candidate position on the target workpiece Wo inferred by the inference unit 54, using the pixel and depth information in the proximity of the desirable candidate position on the image, and the inclined angles of the estimated three-dimensional plane and the image plane may be calculated to three-dimensionally compensate the picking posture.

In the case where the target workpiece Wo is held by the pair of gripping fingers 212, and a longitudinal axis of the target workpiece Wo stands vertically to the image plane, the picking hand 21 may be disposed on the end surface side of the target workpiece Wo to pick the target workpiece Wo. In this case, the user may set and teach the target position at the center of the end surface of the target workpiece Wo in the two-dimensional camera image. Furthermore, in the case where the longitudinal axis of the target workpiece Wo is inclined with respect to the normal direction of the image plane, it is desirable that the picking hand 21 is inclined according to the posture of the target workpiece Wo to pick the target workpiece Wo. However, when the picking hand 21 moves in the normal direction of the image plane toward the target position at the center of the end surface of the target workpiece Wo, the gripping fingers 212 interfere with the end surface of the target workpiece Wo during the movement, even when the picking hand 21 is inclined according to the target workpiece Wo. To prevent such interference, it is preferable that the control unit 55 controls the robot 20 so that the picking hand 21 approaches the target workpiece Wo and moves along the longitudinal axis direction of the target workpiece Wo. In this way, as a method of determining a desirable approach direction of the picking hand 21, one three-dimensional plane may be estimated, with respect to a desirable candidate position on the target workpiece Wo inferred by the inference unit 54, using the pixel and depth information in the proximity of the desirable candidate position on the image, and the robot 20 may be controlled so that the picking hand 21 approaches the target workpiece Wo along the normal direction of the three-dimensional plane reflecting the inclination of the picking surface of the workpiece in the proximity of the picking target position.

The teaching unit 52 may be configured to draw and display a simple mark such as a small dot, a circle, or a triangle at a picking position taught by the user without displaying the above-described two-dimensional virtual hand P, to perform the teaching. Even when the two-dimensional virtual hand P is not displayed, from the simple mark, the user can know a position on the two-dimensional image that has been taught and a position on the two-dimensional image that has not been taught, and whether the total number of teaching positions is too small. Furthermore, the user can check whether the position that has already been taught really deviates from the center of the workpiece and whether an unintended position has been erroneously taught (for example, the mouse is erroneously clicked twice at the proximal position). Furthermore, in the case where the teaching positions are of different types, i.e., in the case where a plurality of kinds of workpieces coexist, for example, the teaching may be performed such that different marks are drawn and displayed on teaching positions on the different workpieces, a dot is drawn on a teaching position on a columnar workpiece, and a triangle is drawn on a teaching position on a cubic workpiece, thereby making the teaching positions distinguishable from each other.

The teaching unit 52 may be configured to numerically display a value of the depth of the pixel in the two-dimensional image in real time, the pixel being normally indicated by the arrow pointer of the mouse, without displaying the above-described two-dimensional virtual hand P, to perform the teaching. In the case where the relative vertical positions of the plurality of workpieces are difficult to be determined from the two-dimensional image, the user moves the mouse to a plurality of candidate positions, and checks and compares the displayed values of the depths at the respective positions, which makes it possible to recognize the relative vertical positions and certainly teach the correct picking order.

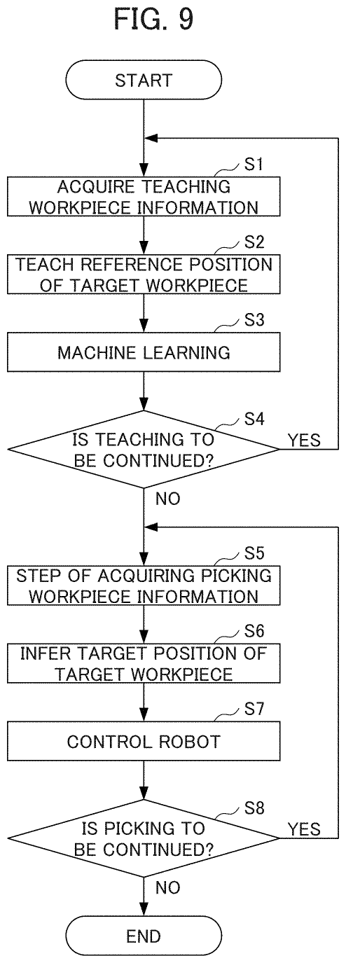

FIG. 9 illustrates a procedure of a method of picking a workpiece by the picking system 1. The method includes a step of acquiring a two-dimensional camera image showing a plurality of workpieces W and a surrounding environment to enable a user to perform teaching (Step S1: a teaching workpiece information acquisition step), a step of teaching at least a teaching position which is a picking position of a target workpiece Wo to be picked from among the plurality of workpieces W by the user (Step S2: a teaching step), a step of generating a trained model by machine learning based on training input data obtained by adding, to the two-dimensional camera image, teaching data in the teaching step (Step S3: a training step), a step of checking whether further teaching is to be performed or whether the teaching data being taught is to be corrected (Step S4: a teaching continuation checking step), a step of acquiring a two-dimensional camera image of a plurality of workpieces W to pick the workpiece W (Step S5: a picking workpiece information acquisition step), a step of inferring at least a picking position of the target workpiece Wo based on the two-dimensional camera using the trained model (Step S6: an inference step), a step of controlling a robot 20 to pick the target workpiece Wo by a picking hand 21 based on the picking position of the target workpiece inferred by the inference step (Step S7: a robot control step), and a step of checking whether to continue to pick the workpiece W (Step S8: a picking continuation checking step).

In the teaching workpiece information acquisition step of Step S1, the acquisition unit 51 may acquire only a plurality of two-dimensional camera images from the information acquisition device 10 to estimate the depth information. Since a camera for capturing a two-dimensional camera image is relatively inexpensive, the two-dimensional camera image is used, making it possible to reduce the equipment cost of the information acquisition device 10 and reduce the introduction cost of the picking system 1. As for the necessary depth information, the information acquisition device 10 fixed to a movement mechanism or a hand tip of the robot to estimate the depth using the movement mechanism or the movement operation of the robot, and a plurality of two-dimensional camera images captured from the different positions and angles. Specifically, this can be implemented in the same method as the above-described method of estimating the depth information by one camera. To acquire the two-and-a-half dimensional data (data including a two-dimensional camera image and depth information for each pixel of the two-dimensional camera image), the information acquisition device 10 may have a distance sensor such as an acoustic sensor, a laser scanner, or a second camera to measure a distance to the workpiece.

In the teaching step of Step S2, by means of the teaching unit 52, a two-dimensional picking position or a picking position with the depth information of the target workpiece Wo to be picked is input on the two-dimensional camera image displayed on the display device 30. The two-dimensional camera image is less likely to cause lack of information than the depth image and enables the user to grasp a state of the workpieces W in almost the same situation as when the user directly views an actual object, which makes it possible to perform the teaching sufficiently using the findings of the user. The above-described method also enables the teaching of the picking posture and the like.

In the training step of Step S3, the training unit 53 generates, by machine learning, a trained model for inferring at least a desired position having a peripheral image having characteristics common with those of the peripheral image of the teaching position taught in the teaching step and a two-dimensional picking position or a picking position with the depth information of the target workpiece Wo to be picked. Generating the trained model by machine learning in this manner enables a user lacking the vision technical knowledge and the specialized knowledge about programming of the mechanism and the controller 50 of the robot 20 to easily generate an appropriate trained model, which makes it possible for the picking system 1 to automatically infer and pick the target workpiece Wo. In the case where the picking posture and the like are further taught, the training unit 53 also learns the picking posture and the like, and also generates the trained model for inferring the picking posture and the like.

In the teaching continuation checking step of Step S4, it is checked whether the teaching is continued, and when the teaching is continued, the process returns to Step S1, and when the teaching is not continued, the process proceeds to Step S5.

In the picking workpiece information acquisition step of Step S5, the acquisition unit 51 acquires the two-and-a-half dimensional image data (data including a two-dimensional camera image and depth information for each pixel of the two-dimensional camera image) from the information acquisition device 10. In the picking workpiece information acquisition step, the two-dimensional camera image and depth of the current plurality of workpieces W are acquired.

In the inference step of Step S6, the inference unit 54 infers at least a two-dimensional picking target position or a picking target position with the depth information of the target workpiece Wo according to the trained model. In this manner, the inference unit 54 infers at least the target position of the target workpiece Wo according to the trained model, which makes it possible to automatically pick the workpiece W without asking for a user's decision. In the case where the picking posture and the like are further taught, and the training is performed, the inference unit 54 also infer the picking posture and the like.

In the robot control step of Step S7, the control unit 55 controls the robot 20 to hold and pick the target workpiece Wo by the picking hand 21. The control unit 55 controls the robot 20 to appropriately operate the picking hand 21 according to a target two-dimensional picking position obtained by adding the depth information, the target two-dimension picking position being inferred by the inference unit 54, or a target picking position with the depth information inferred by the inference unit 54.

In the picking continuation checking step of Step S8, it is checked whether the picking of the workpiece W is continued, and when the picking is continued, the process returns to Step S5, and when the picking is not continued, the process ends.

As described above, according to the picking system 1 and the method using the picking system 1, the workpiece can be appropriately picked by machine learning. Therefore, the picking system 1 can be used for a new workpiece without special knowledge.

### SECOND EMBODIMENT

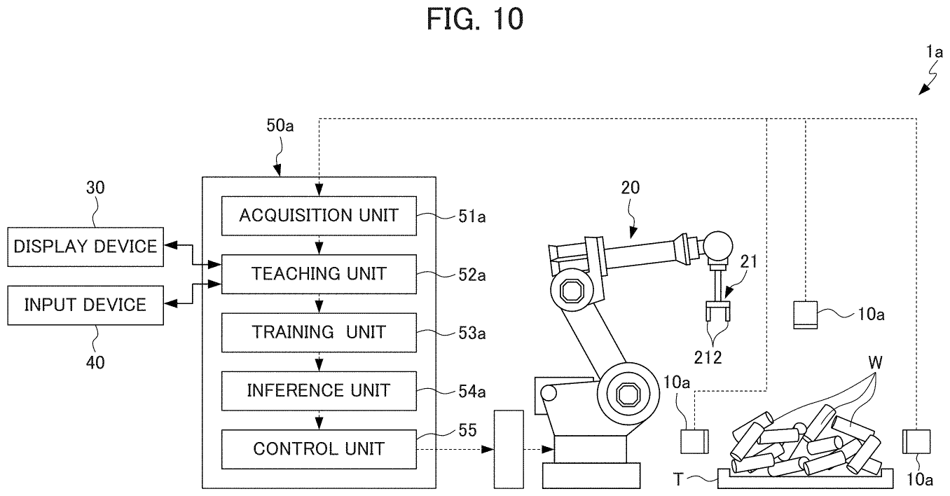

FIG. 10 illustrates a configuration of a picking system 1a according to a second embodiment. The picking system 1a is a system for picking a plurality of workpieces W one by one from a zone (on a tray T) containing the workpieces W. In the picking system 1a of the second embodiment, constituent elements similar to those in the picking system 1 of the first embodiment are denoted by the same reference signs, and redundant description will be omitted.

The picking system 1a includes an information acquisition device 10a configured to capture three-dimensional point cloud data of a plurality of workpieces inside a tray T in which the workpieces W are accommodated to randomly overlap with one another, a robot 20 configured to pick a workpiece W from the tray T, a display device 30 configured to display the three-dimensional point cloud data on a viewpoint changeable 3D view, an input device 40 that allows a user to perform an input operation, and a controller 50a configured to control the robot 20, the display device 30, and the input device 40.

The information acquisition device 10a acquires three-dimensional point cloud data of target objects (the plurality of workpieces W and the tray T). Examples of such an information acquisition device 10a may include a stereo camera, a plurality of 3D laser scanners or a 3D laser scanner with a movement mechanism.

The information acquisition device 10a may be configured to further acquire a two-dimensional camera image in addition to the three-dimensional point cloud data of the target objects (the plurality of workpieces W and the tray T). Such an information acquisition device 10a may have a configuration obtained by combining one selected from among a stereo camera, a plurality of 3D laser scanners or a 3D laser scanner equipped with a movement mechanism, with one selected from among a monochromatic camera, an RGB camera, an infrared ray camera, an ultraviolet ray camera, an X ray camera, and an ultrasonic camera. The information acquisition device 10a may be constituted by the stereo camera alone. In this case, there are used the color information of the grayscale image and the three-dimensional point cloud data which are acquired by the stereo camera.

The display device 30 may display the color information of the two-dimensional camera image in addition to the three-dimensional point cloud data on the viewpoint changeable 3D view. Specifically, the display unit 30 also displays the color by adding the color information of each pixel to each three-dimensional point corresponding to the pixel in the two-dimensional camera image. The display unit 30 may display the color information of RGB acquired by the RGB camera, but may display the color information of black and white of the grayscale image acquired by the monochromatic camera.

In addition to the displaying of the three-dimensional point cloud data on the viewpoint changeable 3D view, the display device 30 may draw and display a simple mark such as a small three-dimensional dot, a circle, or a cross mark on a three-dimensional teaching position taught by the user through the teaching unit 52a, which will be described later.

The controller 50a can cause one or a plurality of computer devices to execute an appropriate program, the computer device including a CPU, a memory, a communication interface, and the like. The controller 50a includes an acquisition unit 51a, a teaching unit 52a, a training unit 53a, an inference unit 54a, and a control unit 55.

The acquisition unit 51a acquires three-dimensional point cloud data in a zone containing a plurality of workpieces W, and further acquires a two-dimensional camera image when the information acquisition device 10a acquires the two-dimensional camera image. The acquisition unit 51a may be configured to generate one piece of three-dimensional point cloud data by a calculation process performed by combining a plurality of pieces of measurement data of a plurality of 3D scanners forming the information acquisition device 10a.

The teaching unit 52a is configured to cause the display device 30 to display the three-dimensional point cloud data acquired by the acquisition unit 51a or the three-dimensional point cloud data obtained by adding the color information of the two-dimensional camera image acquired by the acquisition unit 51a on the viewpoint changeable 3D view, and to allow the user to three-dimensionally check the workpieces and the surrounding environment of the workpieces from a plurality of directions or preferably from every direction while changing the viewpoint on the 3D view using the input device 40, thereby making it possible for the user to teach a teaching position which is a three-dimensional picking position of a target workpiece Wo to be picked from among a plurality of workpieces W.

The teaching unit 52a can specify or change a viewpoint of the 3D view in response to an operation from the user through the input device 40 on the viewpoint changeable 3D view, to perform the teaching. For example, the user moves the mouse while clicking on a right button of the mouse to thereby change the viewpoint of the 3D view displaying the three-dimensional point cloud data, recognizes the three-dimensional shapes of the workpieces and the situation surrounding the workpieces from a plurality of directions or preferably from any direction, stops the movement operation of the mouse at the desired viewpoint, and clicks on the desired three-dimensional position from the desired viewpoint using a left button of the mouse to perform the teaching. This makes it possible to recognize the shape of the side surfaces of the workpieces, the target workpiece and the positional relationship in the vertical direction between the target workpiece and the workpieces surrounding the target workpiece, and the situation below the workpieces, which cannot be recognized from the two-dimensional image. For example, from the two-dimensional image captured in the state in which transparent and semitransparent workpieces, and workpieces with strong specular reflection randomly overlap with one another, it is difficult to determine which one is positioned upper than the others or which one is positioned lower than the others, among the plurality of workpieces overlapping with one another. On the viewpoint changeable 3D view, the plurality of workpieces in the state of overlapping with one another can be recognized from various viewpoints, and the positional relationship in the vertical direction between the workpieces can be correctly grasped, which can avoid erroneous teaching causing the workpiece positioned lower than the others to be preferentially picked. In the case a workpiece has a high degree of exposure but an empty space is present directly underneath the workpiece, when the picking hand 21 approaches the workpiece from directly above to attempt to suction and pick the workpiece, the workpiece may escape downward, which may fail in suction. Such a situation cannot be recognized from the two-dimensional image, but can be recognized on the viewpoint changeable 3D view by specifying the viewpoint such that the target workpiece can be seen from an obliquely lateral side. Thus, the situation can be recognized on the viewpoint changeable 3D view, which makes it possible to perform the correct teaching while avoiding such a failure.

The teaching unit 52a may be is configured to cause the display device 30 to display the three-dimensional point cloud data obtained by adding the color information of the two-dimensional camera image acquired by the acquisition unit 51a on the viewpoint changeable 3D view, and to allow the user to three-dimensionally recognize the workpieces and the surrounding environment of the workpieces including the color information, from a plurality of directions or preferably from every direction while the user changes the viewpoint on the 3D view using the input device 40, thereby making it possible for the user to teach a teaching position which is a three-dimensional picking position of a target workpiece Wo to be picked from among a plurality of workpieces W. This enables the user to correctly grasping the workpiece characteristics from the color information and perform the correct teaching. For example, in the case where boxes having exactly the same size and shape and having different colors are arranged to be tightly stacked, it is difficult to determine a boundary line between the adjacent two boxes from only the three-dimensional point cloud data, and therefore it is highly probable that the user erroneously determines the adjacent two boxes as one large-sized box, and performs the erroneous teaching to suction a narrow gap near the boundary line which is positioned at the center of the large-sized box and pick the box. When a gap position is air-suctioned, air leaks, and the picking results in failure. In such a situation, by displaying the three-dimensional point cloud data with the color information, the boundary line can be recognized by the user even when the boxes having different colors are tightly stacked, which makes it possible to prevent erroneous teaching.

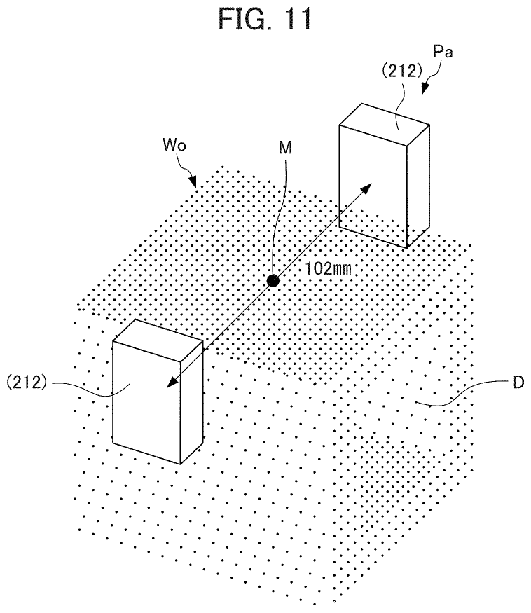

As illustrated in FIG. 11, the teaching unit 52a displays the 3D view of the three-dimensional point cloud data from the viewpoint specified by the user, the three-dimensional shapes and sizes of the pair of gripping fingers 212 of the picking hand 21, an orientation (three-dimensional posture) and a center position of the hand, and a three-dimensional virtual hand Pa reflecting an interval of the hand. The teaching unit 52a may be configured to enable the user to specify the type of picking hand 21, the number of gripping fingers 212, the size of the gripping finger 212 (width □ depth ⊐ height), the degree of freedom of the picking hand 21, an operational constraint value of the interval of the gripping fingers 212, and the like. The virtual hand Pa may be displayed including a center point M between the gripping fingers 212, the center point M indicating the three-dimensional picking target position.

As illustrated in the figure, in the case where the target workpiece Wo has a recess D on a side surface, when the side surfaces including the recess D are gripped by the gripping fingers 212, the picking hand 21 cannot appropriately and stably grip the workpiece W, which may cause the workpiece W to drop. In such a situation, in the case of relying on only the two-dimensional image captured at the viewpoint seen from directly above, the presence or absence of the recess D cannot be recognized, resulting that the erroneous teaching may be performed, causing the gripping fingers 212 to be disposed on the side surfaces including the recess D. However, in such a situation, the user appropriately changes the viewpoint of the 3D view, specifies the viewpoint such that the target workpiece Wo is seen from an obliquely lateral side, and recognizes the shape of the side surfaces of the target workpiece Wo to be gripped, and therefore can teach an appropriate three-dimensional picking position so that the side surface including no recess can be gripped. Furthermore, since the virtual hand Pa has the center point M, the user disposes the center point M in the proximity of the center of gravity of the target workpiece Wo, and thereby can relatively easily teach an appropriate teaching position for stable gripping.

In the case where the number of contact positions between the picking hand 21 and the workpiece W is two or more, the teaching unit 52 may be configured so that the picking hand 21 has the opening and closing degree. The user sets various viewpoints on the 3D view to recognize the workpieces and the situation in the surrounding environment from the various viewpoints, making it possible to easily grasping the appropriate interval (opening and closing degree of the picking hand 21) of the gripping fingers 212 so that the gripping fingers 212 cannot interferes with the surrounding environment when the picking hand 21 approaches the target workpiece Wo, to perform the teaching.

The teaching unit 52a may be configured to allow the user to teach the three-dimensional picking posture when the workpiece W is picked by the picking hand 21. For example, in the case where the workpiece is picked by the picking hand 21 having one suction pad 211, after the user has taught the three-dimensional picking position by a click operation on the left button of the mouse in the above-described method, a three-dimensional place which is a tangent plane centered on the teaching position can be estimated using the taught three-dimensional position and the three-dimensional point cloud inside the upper half toward the viewpoint side of the three-dimensional sphere having a radius r around the taught three-dimensional position. One virtual three-dimensional coordinate system can be estimated in which the normal direction which is an upward direction from the estimated tangent plane toward the viewpoint side is defined as a positive direction of the z axis, the three-dimensional plane is defined as an xy plane, and the teaching position is defined as an original point. Angle error amounts ⊐ₓ, □_{y}, ⊐_{z} around the x axis, the y axis and the z axis between the virtual three-dimensional coordinate system and the three-dimensional reference coordinate system serving as the reference of the picking operation are calculated, and are defined as default teaching values of the three-dimensional picking posture of the picking hand 21. The three-dimensional virtual hand Pa reflecting the three-dimensional shape and size of the picking hand 21 can be drawn as a minimum three-dimensional column including the picking hand 21, for example. The position and posture of the three-dimensional column are determined, drawn and displayed so that a center of the bottom surface of the three-dimensional column coincides with the three-dimensional teaching position, and the three-dimensional posture of the three-dimensional column indicates the default teaching values. When the three-dimensional column displayed in the above-described posture interferes with any surrounding workpiece, the user performs fine adjustment on □ₓ, ⊐_{y}, □_{z} which indicate the default teaching posture. Specifically, ⊐ₓ, □_{y}, □_{z} are adjusted by moving an adjusting bar of each parameter displayed on the teaching unit 52 or are adjusted by directly inputting a value of each parameter, thereby avoiding the interference. When the picking hand 21 goes for picking the workpiece according to the three-dimensional picking posture determined in this manner, the picking hand 21 approaches the workpiece along the approximate normal direction of the curved surface of the workpiece in the proximity of the three-dimensional picking position, which makes it possible to stably obtain a larger contact area to suction and pick the workpiece with preventing the picking hand 21 from interfering with the surrounding workpieces and with preventing the suction pad 211 from changing the target workpiece Wo from the initial position upon capturing the image.

The teaching unit 52a may be configured to cause the display device 30 to display at least of a z height (height from a predetermined reference position) of the virtual hand Pa with respect to the workpiece W and a degree of exposure of the workpiece, to thereby allow the user to teach a picking order of the workpieces W so that the user can preferentially pick the workpiece W with a higher z height and with a higher degree of exposure. As a specific example, on the viewpoint changeable 3D view displayed on the display device 30, the user can recognize the plurality of workpieces in the state of overlapping with one another from the various viewpoints, and can correctly grasp the positional relationship in the vertical direction between the workpieces, and the teaching unit 52a is configured to cause the display device 30 to display the relative z heights of the plurality of workpieces W selected as candidates using the input device 40 (e.g., by a click operation on the mouse), whereby the user can more easily determine the workpiece W which is likely to be picked, for example, is positioned upper than the others. Furthermore, the picking order is not necessarily determined according to the relative z height and the degree of exposure, and the user may teach the workpiece W which is more likely to achieve successful picking based on the findings of the user himself/herself (knowledge, past experience and intuition). For example, when the picking hand 21 approaches or picks the workpiece, the user may perform the teaching in consideration of the fact that the workpiece which is unlikely to cause the interference of the picking hand 21 with the surrounding workpieces is preferentially picked or the fact that a position near the center of gravity of the workpiece W is preferentially gripped to enable the workpiece W to be successfully picked without collapsing the balance.

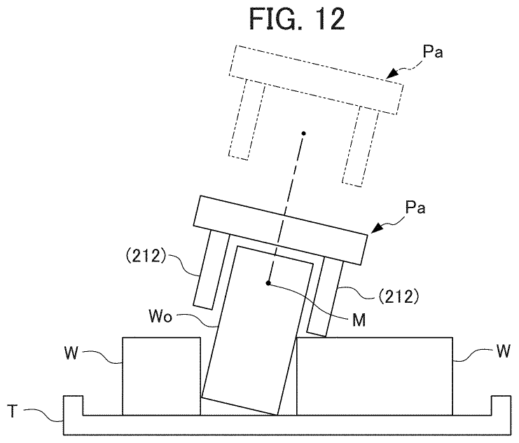

In the case where the picking hand 21 is a gripping hand, the teaching unit 52a may be configured to allow the user to teach the approach direction by operationally displaying the approach direction of the picking hand 21 with respect to the target workpiece Wo, as illustrated in FIG. 12. For example, in the case where an upstanding columnar target workpiece Wo is gripped by the pair of gripping fingers 212 of the picking hand 21, the picking hand 21 may approach the target workpiece Wo vertically from directly above. However, as illustrated in FIG. 12, in the case where the target workpiece Wo is inclined, the gripping fingers 212 firstly contacts the side surfaces of the target workpiece Wo when the picking hand 21 approaches the target workpiece Wo from directly above, which causes the position and posture of the workpiece to change from the initial position and posture upon capturing the image, making it to impossible to grip the workpiece at the desirable position intended by the user, and to appropriately grip the target workpiece Wo. To prevent such a situation, the teaching unit 52a is configured to perform the teaching so that the picking hand 21 should approach the target workpiece Wo in the direction of being inclined along the center axis of the target workpiece Wo. Specifically, the teaching unit 52a may configured so that the user can specify, in the viewpoint changeable 3D view, a three-dimensional position defined as a start point of the approach of the picking hand 21, and a third-dimensional position serving as the teaching position for gripping the target workpiece Wo, the teaching position being defined as an end point of the approach. For example, when the user teaches the start point and end point (teaching position of gripping) by clicking on the left button of the mouse, the three-dimensional virtual hand Pa reflecting the three-dimensional shape and size of the picking hand 21 is displayed at each of the start point and the end point, as the minimum column including the picking hand 21. The user can recognize the displayed three-dimensional virtual hand Pa and the surrounding environment thereof while changing the viewpoint of the 3D view, further add a passing point of the approach between the start point and the end point when finding that the picking hand 21 may interfere with the surrounding workpieces W in the specified approach direction, and perform the teaching so that two or more stages are provided in the approach direction to avoid such interference.

In the case where the picking hand 21 is a gripping hand, the teaching unit 52a may be configured to allow the user to teach a gripping force of the gripping fingers. This can be implemented in the same method as the above-described method of teaching the gripping force which is described in the first embodiment.

In the case where the picking hand 21 is a gripping hand, the teaching unit 52a may be configured to allow the user to teach the gripping stability of the picking hand 21. Specifically, the teaching unit 52a analyzes, using a coulomb friction model, a friction force acting between the gripping fingers 212 and the target workpiece Wo upon contact therebetween, and causes the display device 30 to graphically and numerically display the analysis results of the index representing the gripping stability defined based on the coulomb friction model. The user can adjust the three-dimensional picking position and the three-dimensional picking posture of the picking hand 21 while visually checking the results, and can perform the teaching to obtain higher gripping stability.

The analysis using the coulomb friction model will be specifically described with reference to FIG. 13. In the case where a component on the tangent plane of the contact force generated at each contact position by contact between the target workpiece Wo and the gripping fingers 212 does not exceed the maximum static friction force, it can be determined that the slippage between the fingers and the target workpiece Wo does not occur at the contact position. That is, the contact force f such that the component on the tangent plane of the contact force f between the gripping fingers 212 and the target workpiece Wo does not exceed the maximum static friction force f_{□}=□f_{□} (⊐: coulomb friction coefficient, f_{□}: positive pressure, that is, a component in the contact normal direction of f) can be estimated to be a desired contact force not causing the slippage between the gripping fingers 212 and the target workpiece Wo. Such a desirable contact force is in the three-dimensional conical space illustrated in FIG. 13. A gripping operation by such a desirable contact force can obtain higher gripping stability with preventing the position and posture of the target workpiece Wo from changing from the initial position upon capturing the image due to slippage of the gripping fingers 212 upon gripping and with preventing the target workpiece Wo from dropping due to slippage, thereby enabling the target workpiece Wo to be gripped and picked.

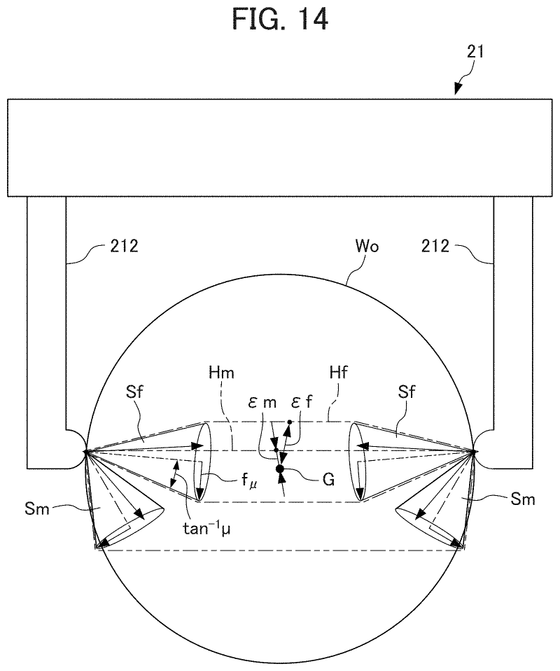

At each contact position as illustrated in FIG. 14, a candidate group of the desirable contact forces f not causing slippage between the gripping fingers 212 and the target workpiece Wo is a three-dimensional conical vector space (force conical space) Sf in which a vertex angle is 2 tan⁻¹□, based on a coulomb friction coefficient □ and a positive pressure f_{□}. The contact force for stably gripping the target workpiece Wo without causing slippage needs to be present inside the force conical space Sf. Since one moment around a center of gravity of the target workpiece Wo is generated by any one contact force f in the force conical shaped space Sf, there is present a conical space of the moment (moment conical space) Sm corresponding to the force conical space Sf of the desirable contact force. Such a desirable moment conical space Sm is defined based on the coulomb friction coefficient □, the positive pressure f_{□}, and the distance vector from the center of gravity G of the target workpiece Wo to each contact position, and the force conical space Sf is another three-dimensional conical vector space which is different in a basic vector.

To stably grip the target workpiece Wo without dropping the target workpiece Wo, a vector of each contact force at each contact position needs to be present inside the corresponding force conical space Sfi (i=1, 2, or the like, i is the total number of contact positions), and each moment around the center of gravity of the target workpiece Wo which is generated by each contact force needs to be present in the corresponding moment conical space Smi (i=1, 2, or the like, i is the total number of contact positions). Accordingly, a three-dimensional minimum convex hull (minimum convex envelop shape containing all) Hf containing all of the force conical spaces Sfi at the plurality of contact positions is a stable candidate group of the desirable force vectors for stably gripping the target workpiece Wo, and the three-dimensional minimum convex hull Hm containing all of the moment conical spaces Smi at the plurality of contact positions is a stable candidate group of the desirable moments for stably gripping the target workpiece Wo. That is, in the case where the center of gravity G of the target workpiece Wo is present in the minimum convex hulls Hf and Hm, the contact force generated between the gripping fingers 212 and the target workpiece Wo is included in the above-described force vector stable candidate group, and the generated moment around the center of gravity of the target workpiece Wo is included in the above-described moment stable candidate group, and therefore such gripping is achieved with preventing the position and posture of the target workpiece Wo from changing from the initial position upon capturing the image due to slippage, with preventing the target workpiece Wo from dropping due to slippage, and without causing the unintentional rotational motion around the center of gravity of the target workpiece Wo, whereby the gripping can be determined to be stable.

Furthermore, as the center of gravity G of the target workpiece Wo is positioned farther from the boundary between the minimum convex hulls Hf and Hm (the shortest distance is long), the center of gravity G is unlikely to fall outside the minimum convex hulls Hf and Hm even when the slippage occurs, and therefore the number of candidates of the force and moment for stable gripping is increased. That is, as the center of gravity G of the target workpiece Wo is positioned farther from the boundary between the minimum convex hulls Hf and Hm (the shortest distance is long), the number of combinations of the force and the moment for the target workpiece Wo balanced without causing the slippage is increased, whereby the gripping stability can be determined to be high. Since as the volume of the minimum convex hull Hf or Hm (volume of the three-dimensional convex space) is increased, the center of gravity G of the target workpiece Wo is more easily contained, the number of candidates of the forces and the moments for stable gripping is increased, whereby the gripping stability can be determined to be high.

As a specific determination index, the gripping stability evaluation value Qo=W₁₁□+W₁V can be used as an example. Here, ⊐ is a shortest distance from the center of gravity G of the target workpiece Wo to the boundary of the minimum convex hull Hf or Hm (a shortest distance □_{f} to the boundary of the minimum convex hull Hf of the force or a shortest distance □ₘ to the boundary of the minimum convex hull Hm of the moment), V is a volume of the minimum convex hull Hf or Hm (a volume V_{f} of the minimum convex hull Hf of the force or a volume Vₘ of the minimum convex hull Hm of the moment), and W₁₁ and W₁₂ are constants. Qo defined in this way can be used regardless of the number of gripping fingers 212 (the number of contact positions).

In this way, in the teaching unit 52a, the index representing the gripping stability is defined using at least one of the volume of the minimum convex hull Hf or Hm calculated using at least one of friction coefficient between the picking hand 21 and the target workpiece Wo at a plurality of contact positions of the virtual hand Pa with respect to the target workpiece Wo and each contact position, or the shortest distance from the center of gravity G of the target workpiece Wo to the boundary of the minimum convex hull.

The teaching unit 52a causes the display device 30 to numerically display the calculation result of the gripping stability evaluation value Qo when the user temporarily inputs the picking position and the posture of the picking hand 21. The user can check whether the gripping stability evaluation value Qo is appropriate as compared to a threshold displayed simultaneously. The teaching unit 52a may be configured to select whether temporarily input picking position and posture of the picking hand 21 are determined as the teaching data or the picking position and the posture of the picking hand 21 are corrected and input again. In addition, the teaching unit 52a may be configured to intuitively facilitate the optimization of the teaching data so as to satisfy the threshold by graphically displaying, on the display device 30, the volume V of the minimum convex hull Hf or Hm and the shortest distance □ from the center of gravity G of the target workpiece Wo.

The teaching unit 52a may be configured to display the three-dimensional point cloud data showing the workpieces W and the tray T and display the three-dimensional picking position and three-dimensional picking posture taught by the user on the viewpoint changeable 3D view, thereby graphically and numerically displaying the calculated three-dimensional minimum convex hulls Hf and Hm, the volumes thereof, and the shortest distance from the center of gravity of the workpiece, and presenting the volume and the threshold of the shortest distance for stable gripping, to display the determination result of the gripping stability. This enables the user to visually check whether the center of gravity G of the target workpiece Wo is inside the Hf and Hm. In the case where it is found that the center of gravity G is outside the Hf and Hm, the user changes the teaching position and the teaching posture and clicks on a recalculation button, so that the minimum convex hulls Hf and Hm reflecting the new teaching position and teaching posture are graphically updated and reflected. By repeating such an operation several times, the user can teach the desirable position and posture such that the center of gravity G of the target workpiece Wo is inside the Hf and Hm while visually checking whether the center of gravity G of the target workpiece Wo is inside the Hf and Hm. The user changes the teaching position and the teaching posture as needed while checking the determination results of the gripping stability, thereby making it possible to perform the teaching to obtain higher gripping stability.

The training unit 53a generates a trained model for inferring a picking position which is a three-dimensional position of the target workpiece Wo by machine learning (supervised learning) based on the training input data including the three-dimensional point cloud data and the teaching position which is the three-dimensional picking position. Specifically, the training unit 53a uses a convolutional neural network to generate the trained model for quantifying and determining the commonality between the point cloud data of the peripheral zone of each three-dimensional position and the point cloud data of the peripheral zone of the teaching position in the three-dimensional point cloud data, more highly evaluate, with higher score, the three-dimensional position with higher commonality with the teaching position, and infer such a three-dimensional position as a target position to which the picking hand 21 should go for more preferential picking.

In the case where the acquisition unit 51a further acquires the two-dimensional camera image, the training unit 53a generates a trained model for inferring a three-dimensional picking position of the target workpiece Wo by machine learning (supervised learning) based on the training input data obtained by adding the teaching data including the teaching position which is the three-dimensional picking position, to the three-dimensional point cloud data and the two-dimensional camera image. Specifically, the training unit 53a uses a convolutional neural network to establish a rule A for quantifying and determining the commonality between the point cloud data of the peripheral zone of each three-dimensional position and the point cloud data of the peripheral zone of the teaching position in the three-dimensional point cloud data. Specifically, the training unit 53 further uses another convolutional neural network to establish a rule B for quantifying and determining the commonality between the camera image of the peripheral zone of each pixel and the camera image of the peripheral zone of the teaching position in the two-dimensional camera image, and more highly evaluate, with higher score, the three-dimensional position with higher commonality with the teaching position comprehensively determined by the rule A and the rule B, so that such a picking position may be inferred as a target position to which the picking hand 21 should go for more preferential picking.

In the case where the three-dimensional picking posture and the like of the picking hand 21 are further taught, the training unit 53a generates a trained model for also inferring a three-dimensional picking posture and the like for the target workpiece Wo by machine learning.

The structure of the convolutional neural network of the training unit 53a may include a plurality of layers such as Conv3D (3D convolutional operation), AvePooling3D (3D average pooling operation), UnPooling 3D (3D pooling inverse operation), Batch Normalization (function that maintains normalization of the data), ReLU (activation function that prevents a vanishing gradient problem), and the like. In such a convolutional neural network, the dimensionality of the three-dimensional point cloud data to be input is reduced to extract necessary three-dimensional characteristic map, the dimensionality of the three-dimensional point cloud data is further returned to the original dimensionality of the three-dimensional point cloud data to predict the evaluation score for each three-dimensional position on the input data, and the predicted value is output in full size. While maintaining the normalization of the data and preventing the vanishing gradient problem, a weighting coefficient of each layer is updated and determined by training so that a difference between the output predicted data and the teaching data decreases gradually. This enables the training unit 53a to generate the trained model so as to evenly search for all the three-dimensional positions on the input three-dimensional point cloud data as candidates, calculate all the predicted scores in full size at once, and obtain, from the candidates, a candidate position with high commonality with the teaching position and with a high possibility of enabling picking to be performed by the picking hand 21. By thus inputting the three-dimensional positions in full size and outputting the predicted scores of all the three-dimensional positions in full size, most appropriate candidate positions can be found without fail. This can prevent a problem in that the most appropriate candidate positions cannot be found if a method of cutting out the three-dimensional point cloud data is worse than the training method that requires pre-processing of cutting out a part of the three-dimensional point cloud data due to unpredictability in full size. The layer depth and complexity of the specific convolutional neural network may be adjusted according to the size of the input three-dimensional point cloud data and the workpiece shape complexity.

The training unit 53a may be configured to determine whether the result of training by machine learning based on the above-described training input data is acceptable or not acceptable, and to display the determination result on the above-described teaching unit 52a, and further to display, on the above-described teaching unit 52a, a plurality of training parameters and adjustment hints when the determination result indicates that the result of training is not acceptable, and to enable the user to adjust the training parameters and perform re-training. For example, the training unit 53 may display the transition diagram and the distribution diagram of the training accuracy with respect to the training input data and the test data, and determine the determination result to be rejected in the case where the training accuracy is not enhanced or is lower than a threshold even when the training progresses. The training unit 53a may calculate accuracy, recall, precision, or the like with respect to the teaching data which is a part of the above-described training input data, so as to determine whether the result of training by the training unit 53a is acceptable or not acceptable, by evaluating whether the prediction can be performed as taught by the user, whether an inappropriate position not taught by the user is erroneously predicted as an appropriate position, how much the know-how taught by the user can be recalled, and how much the trained model generated by the training unit 53a is adapted to the picking of the target workpiece Wo. The training unit 53s displays, on the teaching unit 52a, the above-described transition drawing, distribution drawing, the calculated value of the accuracy, recall, or precision, which represent the training result, and the determination result, and the plurality of training parameters when the determination result is rejected, and further displays, on the teaching unit 52a, the adjustment hints for enhancing the training accuracy and obtaining high accuracy, recall or precision, to present the adjustment hints to the user. The user can adjust the training parameters based on the presented adjustment hints and perform the retraining. In this way, the determination result of the result of training by the training unit 53a and the adjustment hints are presented to the user even when the picking experiment is not actually performed, which makes it possible to generate the trained model with high reliability in a short time.

The training unit 53a may feed not only the teaching position taught by the teaching unit 52a but also the inference result of the three-dimensional picking position inferred by the inference unit 54a, which will be described later, back to the above-described training input data, and perform the machine learning based on the changed training input data to adjust the trained model for inferring a three-dimensional picking position of the target workpiece Wo. For example, the training unit 53a may correct the above-described training input data to exclude, from the teaching data, the three-dimensional picking position with low evaluation score among the results of inference by the inference unit 54a, and perform the machine learning again based on the corrected training input data to adjust the trained model. In addition, the training unit 53a may analyze the characteristics at the three-dimensional picking position with high evaluation score among the results of inference by the inference unit 54a, and automatically assign a label, by internal processing, to define, as the teaching position, a three-dimensional position with high commonality with the inferred three-dimensional picking position with high evaluation score, although being not taught by the user on the three-dimensional point cloud data. This enables the training unit 53a to correct the erroneous determination of the user and generate the trained model with higher accuracy.

In the case where the three-dimensional picking posture and the like are further taught by the teaching unit 52a, the training unit 53a may feed the result of inference further including the three-dimensional picking posture and the like inferred by the inference unit 54a, which will not described layer, back to the above-described training input data, and perform the machine learning based on the changed training input data to adjust the trained model for inferring a three-dimensional picking posture and the like for the target workpiece Wo. For example, the training unit 53a may correct the above-described training input data to exclude, from the teaching data, the three-dimensional picking posture and the like with low evaluation score among the results of inference by the inference unit 54a, and perform the machine learning again based on the corrected training input data to adjust the trained model. In addition, the training unit 53a may analyze the characteristics of the three-dimensional picking posture and the like with high evaluation score among the results of inference by the inference unit 54a, and automatically assign a label by internal processing to add, to the teaching data, the three-dimensional picking posture and the like with high commonality with the inferred three-dimensional picking posture and the like with high evaluation score, although being not taught by the user on the three-dimensional point cloud data.

The training unit 53a may perform the machine learning based on the control result of the picking operation of the robot 20 by the control unit 55 based on not only the three-dimensional position taught by the teaching unit 52a but also the three-dimensional picking position inferred by the inference unit 54a, which will be described later, i.e., the information about the result as to whether the picking operation of the target workpiece Wo performed using the robot 20 has succeeded, to adjust the trained model for inferring a three-dimensional picking position of the target workpiece Wo. Therefore, even when more erroneous teaching positions are included in a plurality of teaching positions taught by the user, the training unit 53a performs the retraining based on the result of the actual picking operation, and corrects the erroneous determination of the user, which makes it possible to generate the trained model with higher accuracy. This function makes it possible to generate the trained model by automatic training without prior teaching by the user, using the result as to whether the operation of going to the picking position randomly determined for picking has succeeded.

In the case where the three-dimensional picking posture and the like are further taught by the teaching unit 52a, the training unit 53a may perform the machine learning based on the inference result further including the three-dimensional picking posture and the like inferred by the inference unit 54a, which will be described later, and based on the control result of the picking operation of the robot 20 by the control unit 55, i.e., the information about the result as to whether the picking operation of the target workpiece Wo performed using the robot 20 has succeeded, to adjust the trained model for further inferring a three-dimensional picking posture and the like for the target workpiece Wo.

In a situation in which the workpieces are left in the tray T after the target workpieces Wo are picked using the robot 20 by the control unit 55 based on the picking positions inferred by the inference unit 54a, which will be described later, the training unit 53a may be configured to also learn such a situation to adjust the trained model. Specifically, the image data when the workpieces W are left in the tray T is displayed on the teaching unit 52a, which enables the user to additionally teach the picking positions. In this way, the user may teach one image showing the left workpieces W, but a plurality of images may be displayed. The data thus additionally taught is also input to the training input data, and the retraining is performed to generate the trained model. A state in which the number of workpieces in the tray T decreases as the picking operation progresses, making it difficult to pick the workpieces, for example, a state in which the workpieces present near the wall side and corner side of the tray T are left easily occurs. Alternatively, in the state in which the left workpieces overlap with one another or in the state in which the workpiece is in the posture which makes it difficult to pick the workpiece, for example, when the whole workpiece at the position corresponding to the teaching position is hidden behind the others and the workpiece posture is not captured by the camera or the workpieces overlap with one another, or when the workpiece is captured by the camera but is largely inclined, the hand may interfere with the tray T or the other workpieces when the workpiece is picked. It is highly probable that the state in which the left workpieces overlap with one another and the workpiece state cannot be supported by the learned model. At this time, the user performs additional teaching about the other positions which are positioned farther from the wall and the corner, the other positions captured by the camera without being hidden by anything else, or the other positions which are not inclined largely, and inputs the additionally taught data to perform the re-training, whereby this problem can be solved.

The inference unit 54a infers at least a three-dimensional picking target position of the target workpiece Wo to be picked, based on the three-dimensional point cloud data acquired by the acquisition unit 51a as the input data, and the trained model generated by the training unit 53a. In the case where the three-dimensional posture and the like of the picking hand 21 are further taught, the inference unit 54a further infers a posture and the like of the picking hand 21 when picking the target workpiece Wo based on the trained model.

In the case where the acquisition unit 51a further acquires the two-dimensional camera image, the inference unit 54a infers at least a three-dimensional picking target position of the target workpiece Wo to be picked, based on the three-dimensional point cloud data and two-dimensional camera image acquired by the acquisition unit 51a as the input data, and the trained model generated by the training unit 53a. In the case where the three-dimensional posture and the like of the picking hand 21 are further taught, the inference unit 54a further infers a three-dimensional picking posture and the like of the picking hand 21 when picking the target workpiece Wo based on the trained model.

In the case where the inference unit 54a infers three-dimensional picking positions of a plurality of target workpieces Wo to be picked, the inference unit 54a may set an order of priority for picking the plurality of target workpieces Wo based on the trained model generated by the training unit 53a.

In the case where the acquisition unit 51a further acquires the two-dimensional camera image, and the inference unit 54a infers the three-dimensional picking positions of the plurality of target workpieces Wo to be picked from the three-dimensional point cloud data and the two-dimensional camera image, the inference unit 54a may set an order of priority for picking the plurality of target workpieces Wo based on the trained model generated by the training unit 53a.

The teaching unit 52a may be configured to allow the user to teach the picking position of the workpiece W based on CAD model information of the workpiece W. That is, the teaching unit 52a checks the three-dimensional point cloud data with the three-dimensional CAD model, and disposes the three-dimensional CAD model so as to coincide with the three-dimensional point cloud data. In this way, even when there are some areas in which the three-dimensional point cloud data cannot be acquired due to limitations of the performance of the information acquisition device 10a, the area in which the data cannot be acquired is interpolated from the three-dimensional CAD model and displayed by matching, with the three-dimensional CAD model, the characteristics (e.g., plane, a hole or a groove, and the like) in another area in which the data has already been acquired, which enables the user to easily perform the teaching while visually checking the interpolated complete three-dimensional data. Alternatively, the teaching unit 52a may be configured to analyze the friction force acting between the picking hand 21 and the gripping fingers 212 based on the three-dimensional CAD drawing disposed to match the three-dimensional point cloud data. This can prevent the user from performing erroneous teaching causing a wrong orientation of the contact surface due to imperfection of the three-dimensional point cloud data, unstable picking with an edge pinched, or picking performed by suctioning characteristic portions such as a hole or a groove, thereby enabling the correct teaching.

In the case where the three-dimensional picking posture and the like are also taught, the teaching unit 52a may be configured to allow the user to teach a three-dimensional picking posture and the like for the workpiece W based on the three-dimensional CAD model information of the workpiece W.

For example, the teaching mistake of the three-dimensional picking posture for the symmetrical workpiece can be eliminated and the teaching mistake due to imperfection of the three-dimensional point cloud data can be eliminated, based on the three-dimensional CAD model disposed to match the three-dimensional point cloud data using a method of matching the three-dimensional CAD model of the above-described workpiece W.

The teaching unit 52a may be configured to display a simple mark such as a dot, a circle, or a cross mark at a picking position taught by the user without displaying the above-described three-dimensional virtual hand P, to perform the teaching.

The teaching unit 52a may be configured to numerically display a z coordinate value of the three-dimensional position on the three-dimensional point cloud data in real time, the three-dimensional position being normally indicated by the arrow pointer of the mouse, without displaying the above-described three-dimensional virtual hand P, to perform the teaching. In the case where the relative vertical positions of the plurality of workpieces are difficult to be visually determined, the user moves the mouse to a plurality of three-dimensional candidate positions, and checks and compares the displayed z coordinate values at the respective positions, which makes it possible to teach the relative vertical positions and certainly teach the correct picking order.

As described above, according to the picking system 1a and the method using the picking system 1a, the workpiece can be appropriately picked by machine learning. Therefore, the picking system 1a can be used for a new workpiece W without special knowledge.

Although embodiments of the picking system and method according to the present disclosure has been described, the picking system and method according to the present disclosure is not limited to the above-described embodiments. The effects described in the above-described embodiments correspond to most preferable effects that are derived from the picking system and method according to the present disclosure, and that are listed merely. The effects of the picking system and method according to the present disclosure are not limited to the effects described in the above-described embodiments.

The picking device according to the present disclosure may be configured to allow the user to teach a teaching position for picking a target workpiece, by selectively using a two-and-a-half dimensional image data or a two-dimensional camera image, three-dimensional point cloud data, or using the three-dimensional point cloud data and the two-dimensional camera image. Further the picking device according to the present disclosure may be configured to allow the user to teach a teaching position for picking a target workpiece by selectively using a depth image.

### EXPLANATION OF REFERENCE NUMERALS

1, 1a: Picking system
10, 10a: Information acquisition device
20: Robot
21: Picking hand
211: Suction pad
212: Gripping finger
30: Display device
40: Input device
50, 50a: Controller
51, 51a: Acquisition unit
52, 52a: Teaching unit
53, 53a: Training unit
54, 54a: Inference unit
55: Control unit
P, Pa: Virtual unit
W: Workpiece
Wo: Target workpiece

1. A picking system, comprising:
a robot having a hand and capable of picking a workpiece using the hand;
an acquisition unit configured to acquire a two-dimensional camera image of a zone containing a plurality of workpieces;
a teaching unit configured to display the two-dimensional camera image and allow teaching a picking position of a target workpiece to be picked by the hand among the plurality of workpieces;
a training unit configured to generate a trained model based on the two-dimensional camera image and the taught picking position;
an inference unit configured to infer a picking position of the target workpiece based on the trained model and the two-dimensional camera image; and
a control unit configured to control the robot to pick the target workpiece by the hand based on the inferred picking position.

2. The picking system according to claim 1, wherein
the acquisition unit acquires image data including depth information for each pixel of the two-dimensional camera image.

3. The picking system according to claim 2, wherein
the teaching unit is capable of displaying at least one of the two-dimensional camera image or the image data.

4. The picking system according to claim 2, wherein
the training unit generates the trained model based on the image data, and
the inference unit infers the picking position of the target workpiece based on the trained model and the image data.

5. The picking system according to claim 1, wherein
the teaching unit is capable of displaying a two-dimensional virtual hand including at least one of information regarding a two-dimensional shape of the hand or a part of the two-dimensional shape, information regarding a size of the hand, information regarding a position of the hand, information regarding a posture of the hand, or information regarding an interval of the hand.

6. The picking system according to claim 2, wherein
the teaching unit is capable of displaying a two-dimensional virtual hand which changes in size according to the depth information of the image data.

7. The picking system according to claim 5, wherein
the teaching unit is configured to allow teaching parameters regarding at least one of a posture of the two-dimensional virtual hand with respect to the workpiece, a picking order of the workpiece, an opening and closing degree of the two-dimensional virtual hand, a gripping force of the two-dimensional virtual hand, or gripping stability of the two-dimensional virtual hand,
the training unit generates the trained model based on the taught parameters, and
the inference unit infers parameters regarding the target workpiece based on the generated trained model and the two-dimensional camera image.

8. The picking system according to claim 7, wherein
the gripping stability is defined using at least one of a contact position of the two-dimensional virtual hand with respect to the workpiece or a friction coefficient between the hand and the workpiece at the contact position.

9. The picking system according to claim 1, wherein
the training unit make a determination on whether a result of training based on training data including the two-dimensional camera image is acceptable or not acceptable, and outputs a result of the determination to the teaching unit, and
in a case where the result of the determination indicates that the result of the training is not acceptable, the training unit outputs training parameters and adjustment hints to the teaching unit.

10. A picking system, comprising:
a robot having a hand and capable of picking a workpiece using the hand;
an acquisition unit configured to acquire three-dimensional point cloud data of a zone containing a plurality of workpieces;
a teaching unit configured to display the three-dimensional point cloud data in a 3D view, display the plurality of workpieces and a surrounding environment from a plurality of directions, and allow teaching a picking position of a target workpiece to be picked by the hand among the plurality of workpieces;
a training unit configured to generate a trained model based on the three-dimensional point cloud data and the taught picking position;
an inference unit configured to infer a picking position of the target workpiece based on the trained model and the three-dimensional point cloud data; and
a control unit configured to control the robot to pick the target workpiece by the hand based on the inferred picking position.

11. The picking system according to claim 10, wherein
the acquisition unit acquires a two-dimensional camera image of the zone containing the plurality of workpieces,
the teaching unit displays the three-dimensional point cloud data together with information of the two-dimensional camera image added to the three-dimensional point cloud data,
the training unit generates the trained model based on the two-dimensional camera image, and
the inference unit infers the picking position of the target workpiece based on the two-dimensional camera image.

12. The picking system according to claim 10, wherein
the teaching unit is capable of displaying a three-dimensional virtual hand including at least one of information regarding a three-dimensional shape of the hand or a part of the three-dimensional shape, information regarding a size of the hand, information regarding a position of the hand, information regarding a posture of the hand, or information regarding an interval of the hand.

13. The picking system according to claim 12, wherein
the teaching unit is configured to allow teaching parameters regarding at least one of a posture of the three-dimensional virtual hand with respect to the workpiece, a picking order of the workpiece, an approach direction of the three-dimensional virtual hand with respect to the workpiece, an opening and closing degree of the three-dimensional virtual hand with respect to the workpiece, a gripping force of the three-dimensional virtual hand, or gripping stability of the three-dimensional virtual hand with respect to the workpiece,
the training unit creates the trained model based on the taught parameters, and
the inference unit infers parameters regarding the target workpiece based on the generated trained model and the three-dimensional point cloud data.

14. The picking system according to claim 13, wherein
the gripping stability is defined using at least one of a contact position of the three-dimensional virtual hand with respect to the workpiece or a friction coefficient between the hand and the workpiece at the contact position.

15. The picking system according to claim 10, wherein
the training unit makes a determination on whether a result of training based on training data including the three-dimensional point cloud data is acceptable or not acceptable, and outputs a result of the determination to the teaching unit, and
in a case where the result of the determination indicates that the result of the training is not acceptable, the training unit outputs training parameters and adjustment hints to the teaching unit.

16. The picking system according to claim 1, wherein
the training unit adjusts the trained model based on result information inferred by the inference unit.

17. The picking system according to claim 1, wherein
the training unit generates the trained model based on result information of a picking operation of the robot.

18. The picking system according to claim 1, wherein
the teaching unit allows teaching based on CAD model information of the workpiece.

19. A method of picking a target workpiece from a zone containing a plurality of workpieces using a robot capable of picking a workpiece by a hand, the method comprising:
acquiring a two-dimensional camera image of the zone containing the plurality of workpieces;
displaying the two-dimensional camera image and teaching a picking position of a target workpiece to be picked by the hand among the plurality of workpieces;
generating a trained model based on the two-dimensional camera image and the taught picking position;
inferring a picking position of the target workpiece based on the trained model and the two-dimensional camera image; and
controlling the robot to pick the target workpiece by the hand based on the inferred picking position.

20. A method of picking a target workpiece from a zone containing a plurality of workpieces using a robot capable of picking a workpiece by a hand, the method comprising:
acquiring three-dimensional point cloud data of the zone containing the plurality of workpieces;
displaying the three-dimensional point cloud data in a 3D view and displaying the plurality of workpieces and a surrounding environment from a plurality of directions, and teaching a picking position of a target workpiece to be picked by the hand among the plurality of workpieces;
generating a trained model based on the three-dimensional point cloud data and the taught picking position;
inferring a picking position of the target workpiece based on the trained model and the three-dimensional point cloud data; and
controlling the robot to pick the target workpiece by the hand based on the inferred picking position.
